(19) United States
(12) Patent Application Publication
(10) Pub. No.: US 2006/0179163 A1
(43) Pub. Date: Aug. 10, 2006

(54) Disk array device

(75) Inventors: Ryosuke Muramatsu, Odawara (JP); Koichi Okada, Odawara (JP); Akiyori Tamura, Kaisei (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/103,595

(22) Filed: Apr. 12, 2005

(30) Foreign Application Priority Data
Feb. 10, 2005 (JP) 2005-034692

(51) Int. Cl. G06F 3/00

(52) U.S. Cl. 710/1

(57) ABSTRACT

In the disk array device, the critical I/O from the host can be responded regardless of the state of the storage unit to be accessed and without occurring an answer delay and system down so that both of the I/O performance and the system reliability can be improved. In the disk array device, a DKC to control data storage to a HDD includes CM to perform the data I/O processing to the HDD responsive to the I/O request from the host. A response impossible state due to the life extension process may be occurred in the HDD. The DKC determines the specified I/O pattern in the received I/O and previously performs the cache control to the critical I/O target data associated with the specified I/O pattern using a CM according to the information in the DB. The critical I/O request is responded using the cache resident data on the CM.

### CROSS-REFERENCE TO RELATED APPLICATION

The present application claims priority from Japanese Patent Application JP 2005-034692 filed on Feb. 10, 2005, the content of which is hereby incorporated by reference into this application.

### TECHNICAL FIELD OF THE INVENTION

The present invention relates to a disk array device (storage device) having a storage unit such as a hard disk drive (HDD) and a storage control unit (hereinafter referred to as DKC) to control data storage to the storage unit and being capable of performing RAID control. Especially, the present invention relates to a technology for improving data input/output (I/O) utilizing a cache memory (CM), and a technology for improving the system reliability.

### BACKGROUND OF THE INVENTION

(1) The disk array device as an external storage unit has response capability to store data in a storage volume on the disk array responsive to an I/O request and a command from the other devices such as a host computer (hereinafter referred to as a host) communicatively connected through means of communication.

Conventionally, in the disk array device including the DKC with the CM, the I/O data for the disk of the storage unit has been cached on the CM so that the cache control to improve the efficiency of the data I/O from the host to the disk is performed.

Additionally, as for the cache control, it has been allowed the specified data to be resided on the CM according to the instruction from a host or the like (hereinafter referred to as “cache resident ON” and also it has been allowed the resident state to be released (hereinafter referred to as “cache resident OFF”. Such I/O from the host to the cache data resided on the CM can be efficiently performed because it can be responded without accessing the disk.

An example of the technology of the cache control in the external storage unit is described in Japanese Patent Application Laid-Open No. 2001-27967.

(2) In the disk array device, there is a device using a plurality of HDDs through a single drive I/F such as SCSI and FibreChannel (hereinafter referred to as FC) as the interface for the HDD (hereinafter referred to drive I/F). Alternatively, there is a device using several types of HDDs through different drive I/Fs by the interface conversion facility. The reliability of the drive as an individual body is different depending on the drive I/F. For example, there are a HDD by a FC interface (hereinafter referred to as FC drive) possesses higher reliability, and a HDD by a serial ATA (hereinafter referred to as SATA) interface (hereinafter referred to as SATA drive) possesses the reliability somewhat lower than FC. Additionally, the control that the drive to which dada is stored is changed depending on the importance of data and the frequency of access is known. The advantage of the FC drive is the reliability, alternatively, the advantage of the SATA drive is low cost.

### SUMMARY OF THE INVENTION

(1) Even if the disk array device employs the storage unit having somewhat lower reliability such as the SATA drive, means for extending the life span of the drive as an individual body thereby the reliability is improved is considered.

(2) However, if the means for improving the reliability of the individual drive is used, the HDD may not respond to the access request for the normal data read/write from the DKC for the required time such as within several seconds (hereinafter referred to as “response impossible state”. In the environment that the above-described response impossible state in the HDD may be occurred, if the target data does not exist on CM when the request for the data I/O is issued from the host, an access to the pertinent HDD in which the target data is stored is occurred, however, when the pertinent HDD can not respond, an response delay is occurred.

(3) Among I/Os for the disk array device from host or the like, the critical I/O not allowing the answer delay for a few seconds to the I/O request exists. In the system which issues such I/O strictly required the response, if the disk array device can not normally respond to the host system within the time limit (hereinafter referred to as required response time), an error and system down may be occurred. That is to say, provided that the HDD to be accessed can not respond when the critical I/O request from the host is received at DKC, an error and so forth is occurred if the HDD can not respond within the required response time due to the answer delay. Provided that the required response time of the I/O from the host is longer than the duration for the response impossible state in the HDD to be accessed, the HDD responds after the response impossible state is recovered so that the normal response can be performed. However, adversely, if the required response time from the host in the I/O is shorter than the duration for the response impossible state in the HDD to be accessed, an answer delay and so forth is occurred so that it results in error.

The present invention is put into practice considering the above-described problem. The object of the present invention is that a technology for the disk array device which can respond to the critical I/O strictly required the response from the host regardless of the response impossible state in the storage unit to be accessed such as a SATA drive and without occurring an error and system down, and can improve both of the I/O performance and the system reliability is provided. The following is a brief description of the gist of the representative elements of the invention laid open in this application.

(1) In order to achieve the above-described object, the disk array device of the present invention comprises one or more storage unit such as HDD and a storage control unit (DKC) having CM to control to data storage to the storage unit, allows RAID control, and performs the data I/O to an area in the storage unit according to I/O request from the other devices such as the host communicatively connected through means of communication such as a network. Wherein the disk array device further comprises means for previously performing the cache control to respond to the critical I/O from the host responsive to the determination of the I/O pattern according to definition information as described bellow.

In the storage unit, the response impossible state that it can not respond to the access request to read and write data to the area in the storage unit corresponding to the I/O request from the DKC may be occurred for the required time. The critical I/O means an I/O from mainly the host whose required response time is shorter than the duration for the response impossible state in the storage unit to be accessed thereby an answer delay may be occurred.

There is a host system which comprises a host to issue the I/O request and a program to operate on the host. The host system may issue not only normal I/O but also the critical I/O request. The disk array device of the present invention processes the I/O from other devices including such host system.

The critical I/O in the storage control unit is identified and estimated by associating the specified I/O pattern in the definition information with the critical I/O. The association is based on the pre- or post-evaluation/analysis regarding the I/O from the host system in the disk array device or the external devices. When the disk array device receives the specified I/O pattern from the host system, the received specified I/O or the I/O to be subsequently received is identified and estimated as the critical I/O according to the association in the definition information. If the required response time for the I/O is not known to the disk array device, the disk array device can respond to the critical I/O according to the association.

The storage control unit determines the specified I/O pattern in the I/O and previously performs the cache control to the target data of the critical I/O associated with the specified I/O pattern using the CM based on the definition information. If the critical I/O is actually occurred, the critical I/O is responded using the cache controlled target data on the CM.

In the disk array device, the I/O pattern in the I/O sequence consisting of one or more I/O actually received from other devices including the host (actual I/O pattern) is determined based on the definition information registered in the database (DB) held in the disk array device so that the specified I/O pattern is extracted.

The actual I/O pattern in the I/O sequence is compared with the information of the reference I/O pattern corresponding to the host system which is stored in the database as the definite information (the defined I/O pattern) to determine whether they are matched or not so that the I/O pattern is extracted.

The database contains the information of the defined I/O pattern and the cache control information corresponded thereto. The host information indicative of the host system and the critical I/O also may be corresponded to the information of the defined I/O pattern. The cache control information correspondingly instructs what cache control is performed to the specified data. The cache control information includes the address information indicative of the control target data and the information indicative of content of the cache control. The content of the cache control includes cache resident control such that the control target data resides on CM i.e. the cache resident ON.

(2) Another disk array device of the present invention further comprises means for capturing the I/O trace of the I/O from other devices including the host. For example, a supervising unit (SVP) connected to the disk array device and having a processor to maintain and to manage the disk array device instructs the DKC to start and terminate to capture the I/O trace through the operator. The DKC captures the I/O trace from the host within the time for capturing according to the instruction and saves the captured information together with the host information in the disk array device or the SVP. The information is used to determine the I/O pattern and retrieve in the external devices.

(3) Another disk array device of the present invention further comprises means for determining the similarity in the comparison between the actual I/O pattern in the I/O sequence and the defined I/O pattern to apply the cache control depending on the similarity. When the similarity between the actual I/O pattern and the defined I/O pattern falls within an allowance in the comparison, the DKC applies the cache control information corresponding to the pertinent defined I/O pattern to the similar actual I/O pattern so that the cache control is performed. The disk array device has DBs containing different registered contents, one of which contains information based on the similarity determination information, and the other of which contains information based on the presence or absence of the similarity of the I/O pattern. For example, the disk array holds the information of the defined I/O pattern as the defined DB and the information including the similar I/O pattern as the additional DB.

(4) Another disk array device of the present invention further comprises means for retrieving the information related to the critical I/O control, such as the I/O trace capture in the disk array device, the extracted I/O pattern, the DB or the defined information in units of the external maintenance center or the like through means of communication such as network and the SVP. For example, the related information such as the I/O trace held in the disk array device is retrieved in the SVP through the SVP process, and further transmitted to the unit in the maintenance center from the SVP through the means of communication to retrieve. The related information from one or more disk array devices is retrieved in the external devices such as the unit of the maintenance center or the unit of a verification center connected to the maintenance center. Verification and analysis are performed in the external devices utilizing the retrieved information so that the information of the I/O pattern from host and the available cache control information for the I/O pattern are created or updated.

(5) Another disk array device of the present invention further comprises means for transmitting the latest definition information in the DB which is created based on the information retrieved in the external devices to the disk array device or the SVP and reflecting it in the DB held in the disk array device to update. Thereby the defined DB held in the disk array device is updated.

(6) Another disk array device of the present invention further comprises means connected to the external devices through the means of communication and the SVP for controlling the critical I/O. In the configuration including a plurality of disk array devices, the updated DB information is transmitted and distributed from the external devices to all or a part of the plurality of disk array devices through the means of communication and the SVP. Receiving the updated DB information, the disk array devices reflect it in the DB information therein to update. New definition information is applied to the plurality of disk array devices all together.

(7) As for the state of the storage unit, there are the response possible state that the access request of the normal I/O can be received and processed, alternatively, the response impossible state that the normal I/O can not be received and processed. Taking an example of the response impossible state in the storage unit, there is the state that a life extension process capability provided in the SATA drive is performing an automatic life extension process. The storage unit performs seek operation to the disk for the required time in the life extension process.

(8) The host system to issue the critical I/O is, for instance, a clustered system having a plurality of host communicatively connected to provide the service to client computer using facilities of the disk array devices, alternatively, it is a host in which a specified OS, application and middleware programs are operated. Among the critical I/O from the host of the clustered system, there is an I/O to preferentially control the shared disk provided in the disk array device.

The following is a brief description of the effects obtained from the representative elements of the invention laid open in this application. According to the present invention, the disk array device can respond the critical I/O strictly required the responsibility from the host regardless of the state such as response impossible state in the storage unit to be accessed and without occurring an answer delay and resulting in an error and system down, and can improve both of the I/O performance and the system reliability.

### BRIEF DESCRIPTIONS OF THE DRAWINGS

FIGS. 1A and 1B are a block diagram of the appearance of the hardware of the disk array device according to an embodiment of the present invention;

FIG. 2 is a block diagram of the overall configuration of the information process system including the disk array device according to an embodiment of the present invention;

FIG. 3 is a block diagram of the more detailed hardware configuration of the disk array device according to an embodiment of the present invention;

FIG. 4 is an explanatory view of the configuration of the process regarding the critical I/O control in the disk array device according to an embodiment of the present invention;

FIG. 5 is an explanatory view of the relationship between each table information managed in the DB in the disk array device according to an embodiment of the present invention;

FIG. 6 is an explanatory view of the detailed constructional example of each table information in the DB in the disk array device according to an embodiment of the present invention;

FIG. 7 is a flowchart of the process of the I/O pattern determination in the disk array device according to an embodiment of the present invention;

FIG. 8 is an explanatory view representing the timing relationship between the I/O sequence from the host computer and the control in the disk array device with time base in the disk array device according to an embodiment of the present invention;

FIG. 9 is an explanatory view representing the relationship between the I/O from the host computer and the state of HDD (SATA drive), and an example of process sequence with time base in the disk array device according to an embodiment of the present invention; and

FIG. 10 is a block diagram of more detailed constructional example of the clustered system of FIG. 2 in the disk array device according to an embodiment of the present invention.

### DESCRIPTIONS OF THE PREFERRED EMBODIMENTS

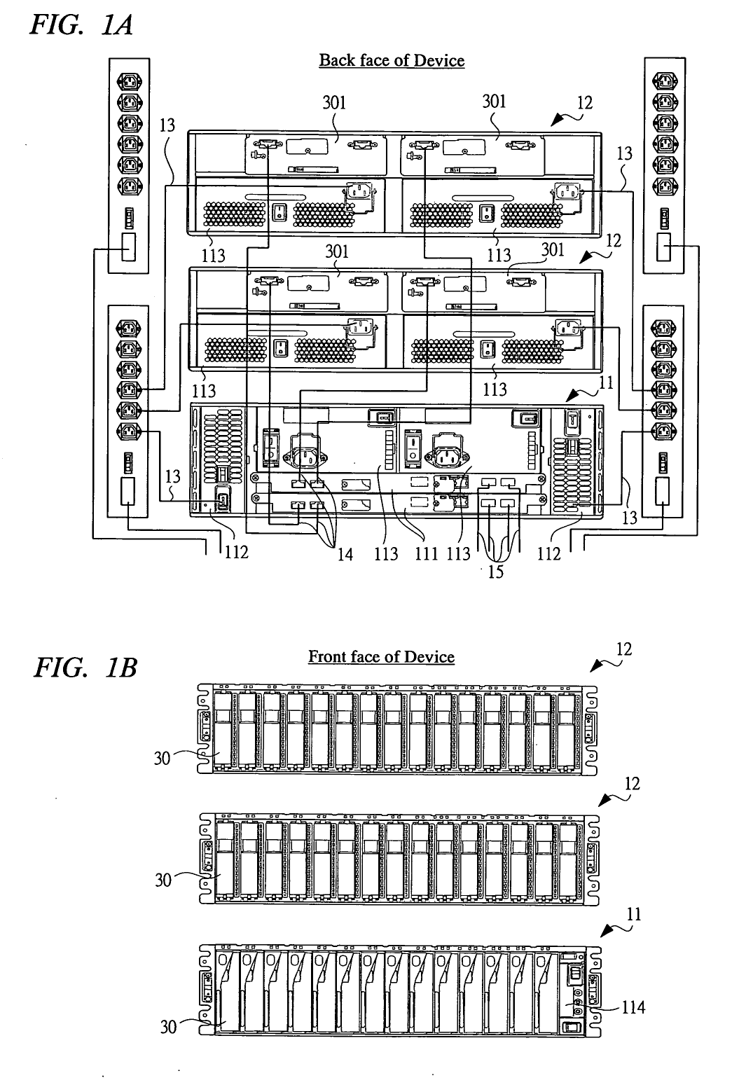

Preferred embodiments of the present invention will be described in detail with reference to the attached drawings. Incidentally, the same reference numerals will be used to designate the same components in all drawings so that the description will be omitted. FIG. 1-FIG. 10 are explanatory views of the disk array device 1 according to each embodiment of the present invention.

Hereinafter, means provided in a disk array device 1 according to the first embodiment for performing the cache control to the critical I/O responsive to the I/O pattern determination from a host 2 is referred to as first means. The host system is some kind of computer system including a host 2. The critical I/O subjected to the I/O response process corresponding the I/O request issued from host 2 and received at the DKC 10 is targeted for the description. In the disk array drive 1 including a SATA drive provided with a life extension process capability, a storage unit such as FC drive and so forth other than the SATA drive may be connected thereto all together. However, for simplification, the SATA drive is only paid attention for ease of explanation in even such case. Additionally, the RAID control is usually performed to the disk array consisting of a plurality of HDDs 30. However, one SATA drive to be accessed I/O is paid attention to consider in even such case for ease of explanation.

### Embodiment 1

The disk array device 1 according to the first embodiment of the present invention is described with reference to FIG. 1-FIG. 10. In the first embodiment, the DKC 10 compares the actual I/O pattern from the host 2 with the defined I/O pattern to extract the specified I/O pattern, previously performs the cache control according to the cache control information corresponding to the specified I/O pattern and then, responds to the critical I/O from the host system using the cache controlled data by the first means composed of the hardware and the software.

<Disk Array Device Hardware (1)>

FIGS. 1A and 1B are a block diagram of the appearance of the overall hardware of the disk array device 1. The configuration is common to each embodiment of the present invention. The disk array device 1 can be constructed of a base housing and a plurality of additional housings, for example. FIG. 1A represents the connection structure of the back face of the device and each housing therebetween. Where, a base housing 11 and two additional housings 12 are represented. AC power is inputted to each housing through a power cable 13. A control board 111 is connected to the external device through an interface cable 15. FIG. 1B represents the front face of the device. A plurality of HDDs 30 is connected in the form of HDU (HDD unit) in the base housing 11, and a battery unit 114 also connected in the base housing 11. The plurality of HDDs 30 is connected in the form of HDU (HDD unit) in the additional housings 12.

The base housing 11 is the minimum constitutional unit of the disk array device 1 and includes the storage control facility taken on the DKC 10. Each additional housings 12 is the option unit of the disk array device 1 and includes the storage facility. The storage control facility controls the storage facility. Boards (substrates) and units to provide various facilities of the disk array device 1 are mounted on each housing. Each board and unit is attachable and detachable according to need.

In each housing, the boards and the units are interconnected through a backplane board provided therein, respectively. Each housing has the internal structure to mount the plurality of HDUs. The structure such as a guide rail to insert/pull the HDU is provided at the position on which each HDU is mounted. The HDU can be freely inserted/drawn at the HDU mounted position by customer engineers. The connector portion of the HDD 30 in the HDU and the connector portion provided in the backplane board are connected thereby the HDU is mounted.

The control board 111, a fan unit 112, an AC/DC power unit 113 and a battery unit 114 constituting the DKC 10 are mounted in the base housing. The AC/DC power unit 113 is connected to the input AC power to supply DC power to each section in the housing. The battery unit 114 supplies power to the cache memory used for improving data input/output performance. The fan unit 112 transmits air to the housing thereby the housing is air-cooled. Where, the AC/DC power unit 113 is configured in double system in order to assure the security of the power supply.

Each facility such as the after-mentioned CHA 110 and CM130 is packaged on the control board 111. Another configuration of the disk array device that each facility can be mounted the base housing as a board other than the control board 111 or a control package may be applied.

A plurality of HDUs is capable of inserting/pulling connected and accommodated in line in the additional housing 12. The HDU includes the HDD 30 and has a mechanism to mount such as a canister to be integrally modularized. The storage area unit in the HDD 30 is a block unit corresponding to LBA (Logical Block Address)

The additional housing 12 includes a housing supervising unit 301 to manage the power supply in the additional housing 12 and the housing. The housing supervising unit 12 is connected to the control board 111 of the base housing 11 through an inter-housing cable 14. A circuit to monitor the power supply state in the additional housing 12 and the state of the HDD 30 is packaged in the housing supervising unit 301.

<Information Process System>

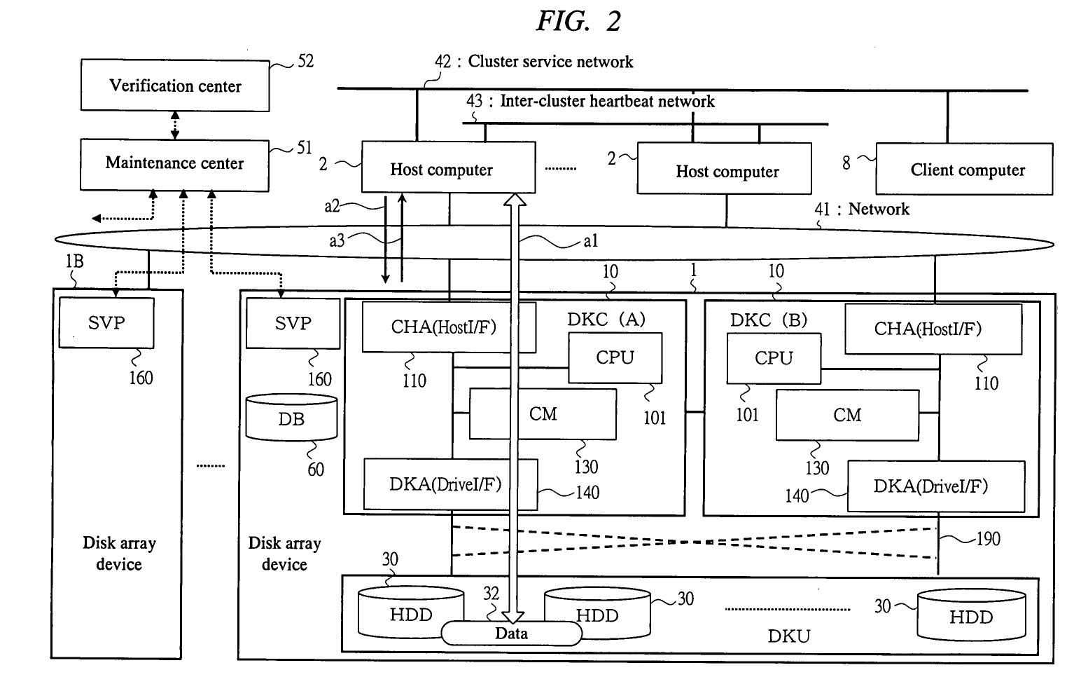

FIG. 2 is a block diagram of the overall configuration of the information process system including the disk array device 1. The information process system comprises a disk array device 1 and 1B, a plurality of host computers (hosts) 2, a client computer 8, a network 41, a cluster service network 42, an inter-cluster heartbeat network 43, a maintenance center 51 and a verification center 52.

The host 2 and the disk array device 1 and 1B are connected through the network 41. The host 2 accesses the disk array device 1 through the network 41 and inputs/outputs data to the storage volume of the disk array device 1. The desk array device 1 only may be connected over the network 41, alternatively, a plurality of similar disk array devices may be connected over the network 41. The disk array device 1B includes the first means as well as the desk array device 1 and may include different facilities other than the first means.

The network 41 is a SAN (Storage Area Network) constituted of the communication equipment such as one or more switches based on FC protocol. The communication through the network 41 is performed according to the FC protocol. In this case, a HBA (Host Bus Adapter) and the CHA 110 are provided with the communication processing facility according to the FC protocol. When the communication is performed over the network 41 according to the FC protocol, the data to be transmitted/received is divided into one or more data blocks by a predetermined data length and controlled in units of a data block. Where, the data I/O request in units of a block (block access request) is transmitted from the host 2 to the disk array device 1 according to the FC protocol.

Additionally, the DCK 10 can communicatively connect to the DCK 10 of another disk array device 1B through the network 41. In this case, the communication is performed according to the FC as well as described above. The network 41 to connect between the host 2 and the DKC 10 may be the common network communicatively connected between the DKCs 10, alternatively may be the different network, and also may be communicatively connected using means of communication other than the network 41 and the FC. The communication between the host 2 and the DKC 10 may be performed using the mainframe protocol such as FICON (Fibre Connection)™ and ESCON (Enterprise System Connection)™, and TCP/IP protocol. Additionally, each DKC 10 is communicatively connected using multiple means of communications, individually.

A SVP 160 and the maintenance center 51 of each disk array device 1 and 1B are communicatively connected through the network 41 or the other means of communication. The maintenance center 51 and the verification center 52 are also communicatively connected. The maintenance center 51 and the verification center 52 include computers having communication facility.

The plurality of hosts 2 and the client computer 8 are communicatively connected through the cluster service network 42. The inter-host 2 is communicatively connected through the inter-cluster heartbeat network 43. A cluster system is composed of the plurality of hosts 2. The hosts 2 provide the cluster service to the client computer 8.

The disk array device 1 comprises the DKC 10, the DKU (Disk Unit) including the group of HDD 30, and the SVP 160. A DB 60 used for controlling by the first means is held in at least one location in the disk array device 1. The SVP 160 is communicatively connected to each DKU 10 through an internal LAN and also communicatively connected to the external maintenance center 51.

The DKC 10 is the double configuration (logical cluster configuration) and has a DKC (A) and a DKC (B) having the same facility. The DKC(A) and the DKC(B) are communicatively connected in the DKC 10. If one DKC becomes down due to a failure, the other DKC continues to operate thereby the service can be continuously provided.

Each DKC 10 is connected to each HDD 30 in the DKU through a connection network 190 and can access data of the storage volume on the HDD 30. The access includes the RAID control.

The DKC 10 comprises a CPU 101, a CHA (Channel Controller) 110 as a host I/F, a CM 130 used for the cache control and a DKA (disk controller) 140 as a drive I/F.

a1 of FIG. 1 represents the I/O targeting data 32 of the storage volume in the disk array device 1 from host 2. The data 32 is targeted for the critical I/O and also subjected to the cache control. a2 represents the I/O request from the host 2 to the disk array device 1 in the I/O (a1). a3 represents the I/O response from the disk array device 1 to the host 2 in the I/O (a1). The I/O (a1) is read/write of the data 32 on the SATA drive through the CHA110, the CM130 and the DKA 140 of the DKC 10. The DKC 10 reads/writes the data 32 targeted for the I/O through the CM130 and the DKA 140 responsive to the receipt of the I/O request (a2) from the host 2 through the CHA 110, and returns an I/O response (a3) to the host 2. The DKC 10 reads the data 32 from the CM 130 or the SATA drive to be accessed responsive to READ command as the I/O request (a2) and returns it as the I/O response (a3), for example. Additionally, the DKC 10 writes the write data to the CM 130 or the SATA drive to be accessed according to the Write command as the I/O request (a2) and the write data and returns that as the I/O response (a3).

The host 2 is a high-order device includes a CPU, a memory, and a communication interface unit and performs I/O to the disk array device 1. The host 2 is an information processor formed of such as a PC, a work station, a server and a mainframe computer. Various programs is executed by the CPU in the host 2 thereby the various facilities as the host can be achieved. The host 2 include such as a software (referred to as a control program) to perform the data I/O access to the disk array device 1 and an application program to provide the information processing service utilizing the access to the disk array device 1. In the host system, some kind of OS, application or middleware is installed on the host 2. The host system is a cluster system composed of a plurality of host 2 in which a cluster software is installed in the present embodiment.

In the host 2, the CPU controls the entire host 2 and executes the program stored in the memory to provide various facilities. The CPU executes the application program thereby the information processing service is provided. Additionally, the CPU executes the control program thereby the storage volume used in the disk array device 1 is controlled. For example, the command to set the storage volume provided in a HDD housing 300 and the LUN and to correspond each other can be transmitted to the DKC 10.

The client computer 8 is a information processor such as a PC including a CPU, a memory and a communication interface unit and provides the cluster service access to the host 2.

The SVP 160 is a computer having a processor to maintain, manage and process the disk array device 1 and is formed to be built in or externally connected to the disk array device 1. The SVP 160 is connected to the DKC 10 through a LAN controller 105 as a component of the disk array device 1 in the present embodiment. The SVP 160 enables various processes such as physically constructing the disk of DKU and setting the LU and installing the program executed on the CHA 110 by the operator's operation. The SVP 160 may be formed of a computer exclusively maintains the disk array device 1 and a general-purpose computer having maintenance and management facility. The information obtained in the DKC10 and the information of the DB 60 are transmitted/received between the SVP 160 and the maintenance center 51 communicatively connected thereto.

The SVP 160 comprises a CPU, a memory, a port, a recording medium reader, an input unit, an output unit and a storage unit. The CPU controls the entire SVP 160 and executes a control program 161 stored in the memory so that the control including the maintenance and management according to the present invention is provided. Various information used for the control according to the present invention is stored in the memory and the storage unit. The port is connected to the internal LAN in the disk array device 1 and the external network thereby to be able to communicate with the processing unit in the DKC 10 and the external device. The operator operates the SVP using the input unit, the output unit, and the recording medium reader.

<Disk Array Device Hardware (2)>

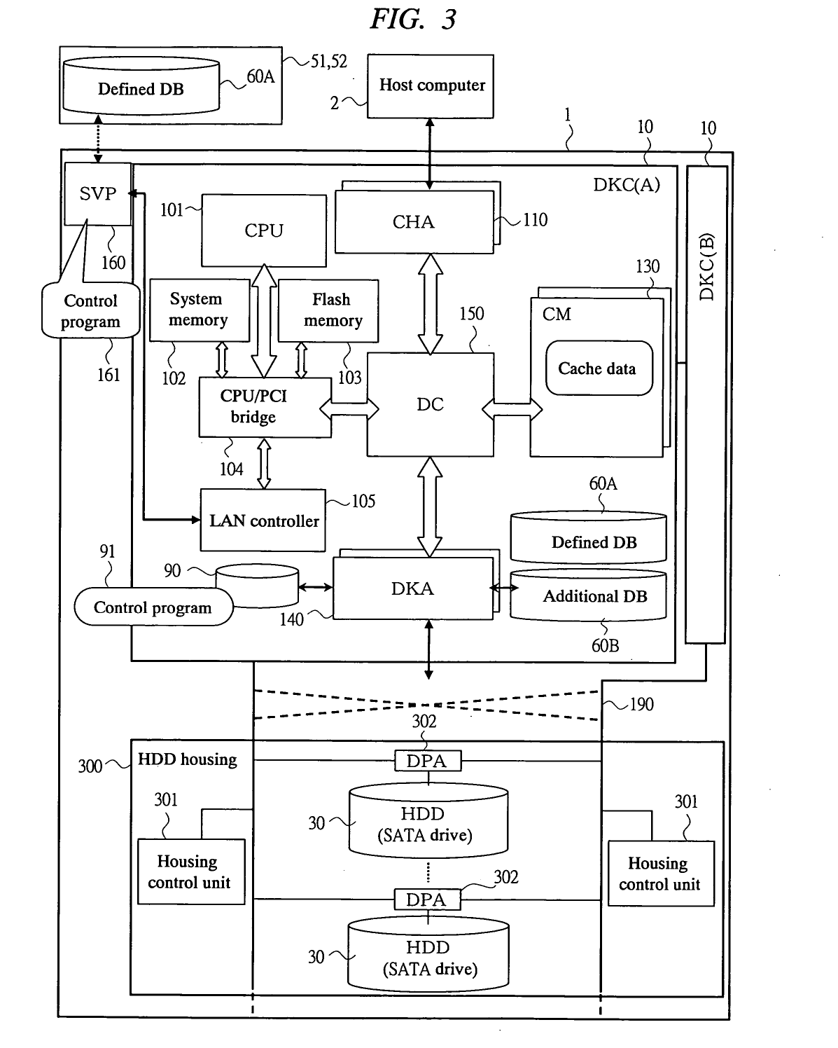

Next, FIG. 3 is a block diagram of an example of the more detailed hardware configuration of the disk array device 1. FIG. 3 only represents the connection of one host 2 and one DKC (A) 10. A defined DB 60A held in the maintenance center 51 through the SVP 160 is externally disposed. The information of the DB 60 held in the disk array device 1 is made up based on the external defined DB 60A.

Each HDD 30 in the HDD housing 300 is communicatively connected to the DKC 10 through the DKA 140 and the network 190. Additionally, each unit such as the CHA 110 and the DKA 140 in the DKC 10 is connected to the SVP 160 through the internal LAN (not shown in the figure) One or more HDD housings 300 are connected through the connection network 190. Such configuration corresponds to the DKU.

<DKC>

The DKC 10 comprises the CPU 101, the system memory 102, the flash memory 103, the CPU/PCI bridge 104, the LAN controller 105, the CHA 110, the CM 130, the DKA 140 and the DC (Data Controller) 150. The defined DB 60A and the additional DB 60B are held on either memory in the DCK 10.

Each unit in the DKC 10 is interconnected through a bus. The bus is such as a PCI bus. The unit of data transmitted through the bus is referred to as a word. The bus of course may be a bus other than the PCI bus. Additionally, one word is limited to 32 bits and may be 8/16/64/128 bits.

The CPU 101 controls the entire disk array device 1. The CPU 101 executes the programs stored in the system memory 102 and the flash memory 103 so that various facilities such as maintaining and managing the HDD 30 and interpreting the request for block access is provided. The system memory 102 is used by the CPU 101 to store mainly the control program, control information and processing data. The flash memory 103 is a nonvolatile memory to store the program to be executed by the CPU 101 and the setting information. The CPU/PCI bridge 104 is a bus bridge for CPU/PCI to connect the CPU 101, the system memory 102, the flash memory 103, the LAN controller 105 and the DC 150. The LAN controller 105 is connected to the CPU/PCI bridge 104 to communicatively connect between each unit in the DKC 10 and the SVP 160 through the internal LAN.

The CHA 110 is provided with an interface to perform the communication processing with the host 2 and other devices such as the disk array device 1B and transmits/receives data between the other devices and the processing unit in the DKC 10. The CHA 110 may be referred to as a host I/F unit. One or more units depending on the host I/F are applicable as the CHA 110. The CHA 110 has a capability to receive the block access request according to the FC protocol. The CHA 110 may receive the block access request according to such as iSCSI protocol depending on the communication mode of the SAN (network 41).

The CHA 110 comprises such as an interface unit, a processor and a memory. The interface unit performs the communication processing with the host 2 through the network 41 and with each unit in the DKC 10 through the DC 150. The processor controls the CHA 110 and communicates with each unit. The processor executes the program stored in the memory so that the capability of the CHA 110 is provided.

The DKA 140 is provided with an interface to transmit/receive to/from the HDD 30 of the HDD housing 300 thereby the data is transmitted/received between the HDD 30 and each unit in the DKC 10. The DKA 140 may be referred to as a drive I/F unit or a disk I/F unit. The DKA 140 has a capability to transmit a data I/O request to the HDD 30 according to the protocol defining the command to control the HDD 30. The DKA 140 can transmit the command for data read/write to the HDD 30 according to the SCSI, FC and SATA protocol depending on the drive I/F. One or more units depending on the drive I/F are applicable as the DKA 140.

The DKA 140 comprises an interface unit, a processor, and a memory. The interface unit performs the communication processing with the HDD 30 through the connection network 190 and with each unit in the DKC 10 through the DC 150. The communication processing between the DKA 140 and the SATA drive (30) is performed according to the SATA protocol in the present embodiment. The processor controls the DKA 140 and communicates with each unit. The processor executes the program stored in the memory so that the capability of the DKA 140 is provided.

The CM 130 is a memory shared in the DKC 10 to store the data transmitted/received between the CHA 110 and the DKA 140 (including the I/O data from the host 2). Especially, the CM 130 is used for the cache control. The data to be cache controlled data is stored in the area set on the CM 130. The CM 130 is configured as a control package including such as a memory board and a memory control circuit.

The DC 150 is circuit constituting a joint to interconnect the CHA 110, the CM 130, the DKA 140 and the CPU/PCI bridge 104 and to transfer data under the control of the CPU 101. The DC 150 may be a circuit of which logic formed on the application specified integrated circuit. The data and the command among the CPU 101, the CHA 110, the CM 130 and the DKA 140 are transmitted/received through the DC 150.

The DKA 140 can access the system disk 90 and the DB 60 including the defined DB 60A and the additional DB 60B. Incidentally, the system disk 90 and the DB 60 is disposed in the DKC 10 in the figure, however, the system disk 90 and the DB 60 are held as the storage volume on the HDD 30 thereby the DKA 140 may read them on either memory of the DKC 10 to use. The CPU 101, the CHA 110 and the like also can access the system disk 90 and the DB 60 through the DKA 140. The DB 60 may be held in the SVP 160 instead of the DKU.

The system disk 90 includes a control program 91 to be executed on the DKC 10. The DB 60 is managed in the system disk 90. The CPU 101 executes the control program 91 thereby to provide the control by the first means. The SVP 160 also executes a control program 161 by the own processor thereby the control associated with the control by the first means.

Additionally, instead of the data I/O processing between the CHA 110 and the DKA 140 is instructed via the CPU 101, the data I/O processing may be directly instructed between the CHA 110 and the DKA 140 without the CPU 101. The processing unit may have both capability of the CHA 110 and the DKA 140. Further the CHA 110 may read/write to the HDD 30. The CM 130 is separately provided from the CHA 110 and the DKA 140, however, the CM 130 may be distributed in the CHA 110 and the DKA 140, respectively.

<DKU>

The SATA drive, the FC drive and so forth may exist all together as the HDD 30 in the HDD housing 300. However, the SATA drive is only connected in the HDD housing 300 in the present embodiment for ease of explanation. The connection network 190 corresponds to the access to the SATA drive.

The storage volume means a storage resource to store data which includes the physical storage volume as a physical storage area provided by the HDD 30 and the logical volume as a storage area logically set on the physical storage volume. The logical volume may be especially referred to as a LU (Logical Unit). The disk array is composed of a plurality of HDDs 30. The storage area for the host 2 can be provided as the RAID group controlled by the RAID control. The unique identifier such as LUN (Logical Unit Number) is provided to each storage volume and managed thereby the storage area designated by the LUN can be provided. The LUN and LBA to designate the I/O target are described in the I/O request from the host 2 to the disk array device 1.

A housing supervising unit 301, a DPA (Dual Port Apparatus) 302 and the HDD (SATA drive) 30 are connected through the line of the connection network 190 in the HDD housing 300.

The housing supervising unit 301 includes an interface to collect and hold the operating state in the HDD housing 300, and processes a request for the operating state report regarding the HDD housing from the DKC 10. The operating state in the HDD housing 300 means the state of each component such as the HDD 30, the power supply unit and the fan.

If the different drive I/Fs exist together in the HDD housing 300, the necessary interface convert facility is provided in the DKC 10 or the DKU thereby to enable the transform processing to respond even if the interface of the DKA140 in the DKC10 is different from that of the HDD 30. For example, if an access from the DKA 140 compatible with the FC interface is performed according to the FC protocol, an interface convert facility for FC-SATA is provided on the connection network 190 to convert to the SATA interface so that the SATA drive can respond. Additionally, a FC chip to process according to the FC protocol may be provided in the DKC 10.

The DPA 302 is a circuit to convert the path connecting the SATA drive with the single port to be a dual port. Generally, the SATA drive has only one drive I/F port (single port). However, most disk array devices have the dual DKC 10 or the dual drive I/F. Accordingly, two access paths to the HDD 30 exist on the connection network 190. Therefore, when the path from the DKC 10 is connected to the SATA drive, the path is converted from the dual port to a single port by the DPA 302. The SATA drive can receive accesses from any path on the connection network 190 as well as the use of the FC drive.

If the FC drive having two drive I/F ports (dual port) is used in the disk array device 1, the DPA 302 is not required. The FC drive having the dual port can read/write from the DKC 10 to the FC drive through the two paths. The FC drive is provided with the facilities such as SES (SCSI Enclosure Service) and ESI (Enclosure Service I/F) prescribed SCSI3 (Small Computer System Interface 3). The SES is a software specification used for monitoring the operating state of various components installed in the HDD housing 300 such as a power supply, a cooling device, an indicator, each HDD and a switch, and reading the state. The ESI is a hardware interface to transmit/receive the SES command and its result. For example, the operating state of each HDD 30 can be checked by using the SES and the ESI.

The HDD 30 as a SATA drive according to the present embodiment has a single port and does not have the facilities such as the SES and the ESI differently from the FC drive. However, the application of the SATA drive including the SES and ESI facilities is not excluded.

As described above, the SATA drive does not have the SES function differently from the FC drive. The housing supervising unit 301 is provided in the HDD housing 300 to accommodate the SATA drive in order to compensate for lack of the SES function.

The housing supervising unit 301 is a microcomputer includes a CPU, a memory and a cache memory therein to collect the disk type, addresses, the operating state and the other management information from each HDD 30 in the HDD housing 300. The housing supervising unit 301 provides the collected information to the DKC 10 according to the SES command from the DKC 10.

If the FC drive is used, each FC drive is connected to the connection network 190 with two FC-AL (Arbitrated Loop) through a PBC (Port Bypass Circuit).

<Normal Data I/O Processing>

The procedure of the normal data I/O processing in the disk array device 1 is as before. The procedure of Write/Read processing to the storage volume (HDD 30) in the disk array device 1 according to Write/Read command form host 2 is described as bellow. Where, the data is transferred among the CPU 101, CHA 110, CM 130 and DKA 140 through the DC 150 as the data is cached in the CM 130.

Firstly, Write processing is as follows. The host 2 transmits an access request (referred to as a write request) for requiring a write to the HDD 30 to the disk array device 1. The CHA 110 receives the write request and the DC 150 transfers the write data associated with the write request to the CM 130 in the disk array device 1. When the write data is transferred to the CM 130, the DC 150 reads the write data from the CM 130 to the DKA 140, and the DKA 140 transmits a command to instruct to write into the HDD 30 to be written. Receiving the command from the DKA 140, the HDD 30 writes the write data into the disc area.

Next, Read processing is as follows. The host 2 transmits an access request (referred to as a read request) for requiring a read to the HDD 30 to the disk array device 1. The CHA 110 receives the read request and the DC 150 transfers the read data address associated with the read request to the DKA 140 in the disk array device 1. The DKA 140 transmits a command to instruct the read from HDD 30 to be read. The DC 150 transfers the read data read from the HDD 30 according to the command to the CM 130. When the read data is transferred to the CM 130, the DC 150 transmits the read data from the CM 130 to the CHA 110. The CHA 110 transmits the read data to the host 2.

<Critical I/O Control>

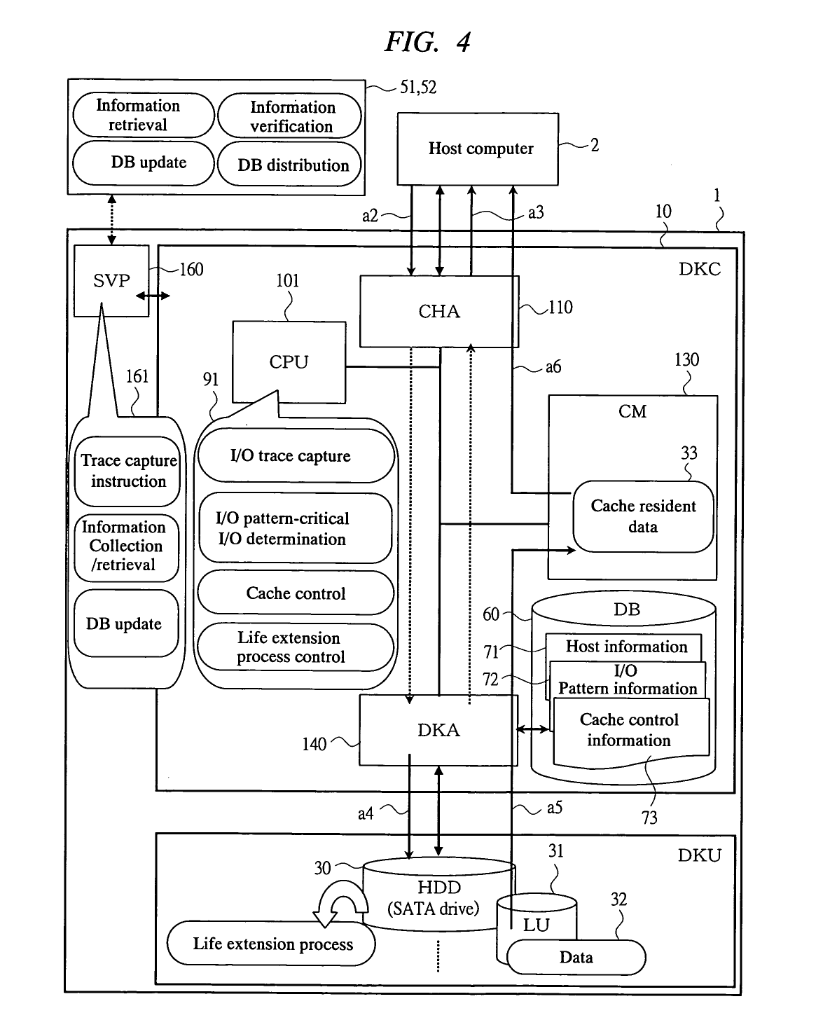

FIG. 4 is an explanatory view of the process regarding the control by the first means in the disk array device 1.

Even if an I/O from the host 2 is the critical I/O, provided that the I/O target data is stored on the CM 130 in the DKC 10, it is possible to immediately respond using the data on the CM 130 without occurring an answer delay due to the response impossible state in the HDD 30. Therefore, in the present disk array device 1, regarding the DKC 10, as for the I/O process to respond to the I/O request received from the host 2, the critical I/O target data 32 or the data associated therewith is previously subjected to the cache control including caching on the area in the CM 130 or executing a staging process before the host 2 issues the critical I/O request in order not to limit the response capability due to the response impossible state in the HDD 30 to be accessed in the I/O. Thereby if the critical I/O is issued, the data cached on the CM 130 can be responded without the answer delay so that the error can be prevented.

The staging process is executed to read the control target data from an area in the HDD 30 to an area in the CM 130 and store it on the CM 130 in order to cache or make the cache resident ON. Alternatively, the destaging process is executed to write the cache data on the CM 130 into the original area in the HDD 30 to reflect and update it.

As for the I/O processing to respond to the I/O request in the DKC 10, the disk array device 1 performs the cache control corresponding to the specified I/O pattern according to the definition information held in the disk array device 1. Therefore, upon receiving the I/O from other devices, the DKC 10 determines the specified I/O pattern associated with the critical I/O from the host 2 by comparing it with the definition information to extract thereby the pre-cache control prepared for issuing the actual critical I/O according to cache control information 73 corresponding to the determined specified I/O pattern. In other words, the host system and its critical I/O of the present issued I/O are estimated from the specified I/O pattern. The received I/O following the specified I/O pattern is estimated as the specified critical I/O.

When one or more I/O (a1) is received from the host 2, the disk array device 1 compares the actual I/O pattern in the I/O sequence with the defined I/O pattern information 72 registered in the defined DB 60A to determine the specified I/O pattern. If the actual I/O pattern from the host 2 coincides with the defined I/O pattern, the cache control is performed according to the cache control information 73 corresponding to the I/O pattern.

In the cache control, especially, the critical I/O target data 32 is made to be cache resident ON state on an area in the CM 130. For example, after the I/O pattern and the critical I/O are determined, the staging process is executed such that the pertinent data 32 on the HDD 30 targeted for the control is read to and stored in the area positioned the CM 130 in the block unit of the LBA, in units of a data set of a plurality block or in units of LU31.

Receiving the critical I/O request from the host 2 after the specified I/O pattern is received and the cache control is performed, the DKC 10 can respond using the cache resident data 33 without performing disk access synchronized with the I/O request because the target I/O data 32 is cached on the CM 130 as the cache resident data 33. Accordingly, even if the HDD 30 is in the response impossible state in performing the life extension process, the DKC 10 can respond within the response time required for the critical I/O without occurring an answer delay.

According to the above-described control, the critical I/O from the host 2 can be controlled by giving priority to the I/O performance regardless of the state of the HDD 30, so that it allows the critical I/O to be normally responded without occurring any error and system down thereby the system reliability is improved.

The cache control information 73 suitable for the specified I/O pattern is previously incorporated in the DKC 10 as the DB 60 in the first embodiment. For example, in the product developmental stage of the present disk array device, the system evaluation and analysis have been performed for each system configuration including the host 2, the regularity of the I/O pattern has been derive from the host 2 and the available cache control information 73 has been created according to the I/O pattern. Further, the information to correspond the I/O pattern 72 to the cache control information 73 and the information including the host information 71 have been compiled into a database. The database has been as the defined DB 60A and incorporated in the disk array device 1.

In FIG. 4, the CPU 101 performs each process such as capturing the I/O trace, determining the I/O pattern-the critical I/O, cache-controlling and controlling the life extension process by executing the control program 91. Each process may be performed by the CHA 110 and the DKA 140 other than the CPU 101. The SVP 160 performs each process such as instructing the trace capturing, collecting and retrieving information and updating the DB by executing the control program 161 (performed after the second embodiment). Units included in the maintenance center 51 and the verification center 52 perform each process such as retrieving information, verifying information, updating the DB and distributing the DB (performed after the second embodiment). The capturing of the I/O trace in the DKC 10 is a process to capture the I/O trace for the I/O from other devices. The captured information is used to determine the I/O pattern. The determination of I/O pattern-critical I/O is a process including the determination of I/O pattern using the DB 60 and corresponds the determined specified I/O pattern to the critical I/O from the host system and the host 2. The cache control is a process to perform a cache control based on the result of the determination of I/O pattern-critical I/O. The life extension process control is a process to perform the access control from the DKC 10 to the HDD 30 on the life extension process in the HDD 30 (SATA drive) so that the life extension process can be effectively performed, however, the process may not need to do. The life extension process control can regularly and temporarily stops the disk access.

In the SVP 160, the instruction of the trace capturing is a process to instruct the DKC 10 to capture the I/O trace. The collection and retrieval of information is a process to collect information for the I/O trace and the additional DB 60B from the disk array device 1 to the SVP 160, transmit the information to the unit of the external maintenance center 51 to retrieve. The update of the DB is a process to update the DB 60 in the disk array device 1 based on the distribution information from the maintenance center 51.

In the maintenance center 51 and the verification center 52, the information retrieval is a process to retrieve information such as the I/O trace from the SVP 160 in each disk array device 1. The information verification is a process to verify the retrieved information so that the definition information for the DB 60 is created by evaluating and analyzing the host system. The update of the DB is a process to update the defined DB 60A based on the definition information newly created by the information verification and further create distribution information as a redistributable form. The distribution of the DB is a process to distribute the distribution information of the updated defined DB 60A to the SVP 160 in the disk array device 1 under the control.

The DB 60 in the DKC 10 includes each table for the host information 71, I/O pattern information 72 and the cache control information 73. The area to store the cache resident data 33 other than the normal I/O cache data is positioned on the CM 130 according to need.

The HDD 30 as the SATA drive has the life extension process capability. The SATA drives automatically perform the life extension process when it does not receive the access request for reading/writing the normal data from the DKC 10. The LU 31 is set on the HDD 30 thereby the I/O is performed to the data 32 in the LU 31. The data 32 is a special data targeted for the critical I/O.

The I/O request (a2) is transmitted from the host 2 to the CHA 110. If the pertinent cache data does not exist on the CM 130, the I/O represented by a4 (disk access) is performed from the DKA 140 to the data 32 in the LU 31 on the HDD 30 according to the I/O request (a2). Alternatively, if the pertinent cache data exists on the CM 130, the response using the cache data represented by a6 (cache response) is performed according to the I/O request (a2). When the data 32 in the HDD 30 is cached or executed the staging process on the CM 130 responsive to performing the cache control for the normal I/O or the cache control by the first means as the access related to the cache control represented by a5 (cache control access), the target data 32 is read to and stored in the area positioned on the CM 130 through the process by the DKA 140. If especially the cache resident control is performed as the cache control by the first means, the data 32 in the LU 31 associated with the critical I/O is made to be resident on the CM 130 as the cache resident data 33.

The CPU 101 controls the I/O (a1) corresponding to the I/O request (a2) from the host 2, determines the I/O pattern and performs the cache control. The information in the system disk 90 and the DB 60 is read out and stored in the system memory 102. When the disk array device 1 is activated, the information in the system disk 90 and the DB 60 is read into the system memory 102.

The CPU 101 monitors the I/O request (command) from the host 2 connected through the CHA 110. Receiving the command from the host 2, the CPU 101 compares the received command with the I/O pattern information 72 in the DB 60 on the system memory 102 to determine the I/O pattern. Recognizing that the sequence corresponding to the defined I/O pattern is issued, the CPU 101 makes the critical I/O target data 32 or the associated data therewith be resident on the CM 130 in units of block of the LBA according to the cache control information 73 according to the I/O pattern from the HDD 30 prior to the DKA 140 (a5). Then, the subsequent I/O request (a2) from the host 2 to the data 32 is responded utilizing the cache resident data 33 on the CM 130 (a6).

<Life Extension Process in HDD>

The SATA drive (30) in the DKU connected to the DKA 140 of the DKC 10 has the life extension process (or long life process) capability. In the state that the SATA drive (30) is connected, when the disk access for the normal data I/O does not exist, the life extension process is automatically started once and executed for the required time such as five seconds and then terminated. In executing the life extension process, the access request for the normal I/O and the critical I/O can not be responded, i.e. it is in the response impossible state.

For example, the DKC 10 temporarily stops the disk access to the SATA drive (30) having the life extension process capability as the life extension process control. Thereby the life extension process is automatically executed in the SATA drive (30) during the temporal stop so that the life extension process capability can be improved. The control is performed such that the disk access is temporarily stopped at the periodic interval such as once an hour.

The object and feature of the life extension process is generally described bellow. The SATA drive (30) has the capability to perform idle seek, i.e. seek operation in idle state/idling to blow off fine dust by regularly moving the head in order to prevent the fine dust from depositing on the specified track. The magnetic surface of the disk in the HDD is coated with lubricant. The seek operation to the head is performed in order to uniformalize the lubricant on the surface.

The operating schedule of the life extension process in the SATA drive (30) is as follows.

HDD 30 usually attempts to start the idle seek after more than definite period of time from the time at which the previous idle seek was finished is lapsed. At this time, if the data access to the HDD is not performed, the HDD 30 starts the idle seek. However, the data access to the HDD is performing at that instant, the HDD 30 attempts to start the idle seek again after the data access is finished. One idle seek is started, performed for the required time, then finished.

Thus the response impossible state to the access request from the DKC 10 is occurred in the HDD 30 due to the life extension process executed in the HDD 30.

Incidentally, the access control from the DKC 10 to the HDD 30 is performed thereby the life extension process may be provided instead that the HDD 30 has the capability to automatically perform the life extension process in itself. For example, the DKC 10 regularly instructs the SATA drive (30) to perform the seek operation independent of the normal I/O. Thereby the effect of the life extension can be achieved in a short period of time.

Even if it is the disk array device 1 using the SATA drive having the reliability somewhat lower than the FC drive, the above-described life extension process capability provided in the SATA drive (30) is executed so that the life time of the individual drive body is extended thereby the reliability can be improved. Accordingly, even if the HDDs 30 with the different reliability level are mixed, i.e. such the FC drive and the SATA drive are combined, the disk array device 1 can be obtained a certain reliability.

<DB>

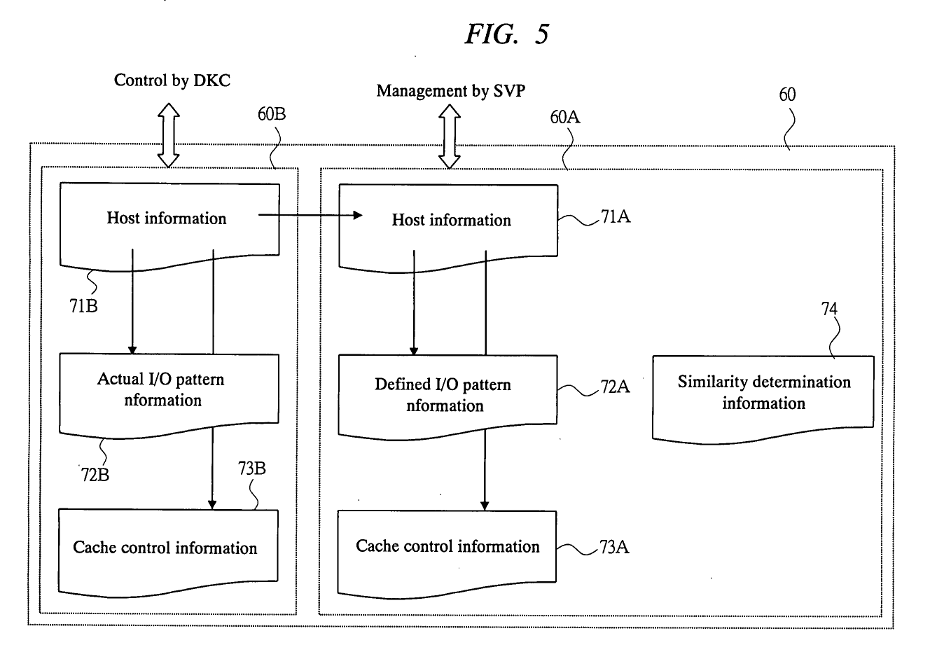

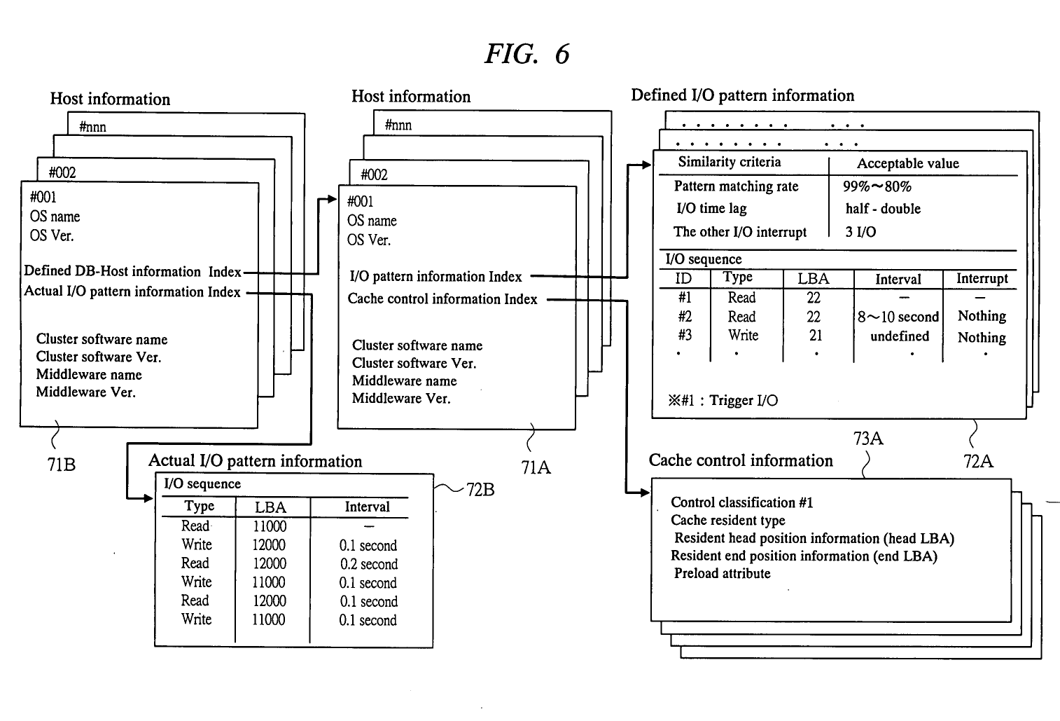

FIG. 5 represents the relationship between each table information managed in the DB 60. FIG. 6 represents the detailed constructional example of each table information in the DB 60. In the DB 60, the specified I/O pattern, the host system or the critical I/O, the control target data and the cache control contents are corresponded in the form of the registered definition information. The DKC 10 reads out and holds the information in the defined DB 60A and the additional DB 60B on any memory. The information table including the host information 71A, the defined I/O pattern information 72A and the cache control information 73A is stored in the defined DB 60A. The information table including the host information 71B, the actual I/O pattern information 72B and the cache control information 73B is stored in the additional DB 60B.

For example, since the specified host system is estimated based on that the I/O sequence from the host 2 is an access to the specified LBA in the HDD 30, the definition information corresponding to the specified host system is registered in the defined DB 60A. According to the result of the system evaluation and analysis, it is known that a predetermined access to the specified LBA is performed by a certain software in a certain host system and the subsequent access is the critical I/O. Therefore, the cache control information 73 is created such that the data to be accessed in the I/O is targeted for the cache resident ON corresponding to the specified I/O pattern thereby the critical I/O can be responded. The information in the defined DB 60A is referred by the DKC 10 and managed by the SVP 160 in FIG. 5. The information in the additional DB 60B is created and controlled by the DKC 10. Similarity determination information 74 is associated with the I/O pattern information 72. Incidentally, the I/O pattern information 72 and the cache control information 73 may be directly corresponded without through the host information 71 in the DB 60.

The defined DB 60A is definite information previously created and is managed through the SVP 160. The additional DB 60B is additional or temporal information newly created depending on the actual operation in the disk array device 1. The available information created as the additional DB 60B may be utilized to reflect in the defined DB 60A.

The host information 71A and 71B are information indicative of the feature of the host system and it can be form referred by the operator through such as SVP 160. The I/O pattern information 72 is the data used to determine the I/O pattern and also used to determine the similarity in the after-described third embodiment. The actual I/O pattern information 72A is the information regarding the I/O pattern actually received and extracted in the DKC 10. The actual I/O pattern information 72B corresponds to the I/O trace information. The defined I/O pattern information 72B is the information regarding the I/O pattern being the reference term to determine the specified I/O pattern. The cache control information 73A and 73B are the information to instruct the cache control such as the cache resident control.

The similarity determination information 74 is used in the third embodiment. Thereby even if the actual I/O pattern is not fully matched with the defined I/O pattern in the I/O sequence, it is assumed to match with the pertinent defined I/O pattern when a certain similarity is appeared within an allowance based on the similarity criteria and the allowed value so that the usual cache control is applied thereto.

In FIG. 6, the host information 71A in the defined DB 60A is described the reference information to determine the critical I/O such as numeral ID (identification information), an I/O pattern information index and a cache control information index, and further, the names of version of the OS, the cluster software or the middleware which are operated in the host 2. Those information can be form referred by the supervisor of DB 60. The I/O pattern information index is the index (link or address) to the defined I/O pattern 72A. The cache control information index is the index to the cache control information 73A.

The host information 71B in the additional DB 60B is described as the additional host information, such as numeral ID, a defined DB-host information index and an actual I/O pattern information index, and further the information of the OS, the cluster software and the middleware operated in the host 2 as well as the defined DB 60A. The defined DB-host information index is the index to the host information 71A in the defined DB. The actual I/O pattern information index is the index to the actual I/O pattern information 72B.

The actual I/O sequence responsive to the I/O received from the host 2 is recorded in the actual I/O pattern information 72B. The I/O sequence is the sequence of the I/O command. One I/O command has information such as I/O type, LBA and interval. The I/O type is Read and Write or the like. The LBA is the address of the HDD 30 to be accessed. The interval of I/O is the time interval to the last received I/O command. The received I/Os from other than the host 2 are not considered in the present embodiment for ease of explanation. In the present embodiment, the head of received command in the I/O sequence is Read command and its destination LBA is “11000”. Next, Write command is received and its access destination LBA is “12000”. Where, the time interval between the last Read command and the Write command is “0.1 second”. Since then, Read command and Write command are sequentially received as above-described order.

The defined I/O pattern information 72A of FIG. 6 includes the similarity determination information 74. The defined I/O pattern information 72A has the tables for each specified I/O pattern. The specified I/O pattern is represented by the I/O sequence. The I/O sequence composed of a plurality of items of the I/O information parallel to the time series. The first item (#1) of the I/O in the I/O sequence is a trigger I/O in the I/O pattern. Where, the similarity determination information 74 is composed of the information regarding the similarity criteria and the corresponding allowed value thereto.

In an example of the defined I/O pattern in the defined I/O pattern information 72A of FIG. 6, one I/O pattern is represented by three I/O sequences (#1-#3). Each I/O has the items including ID, type, LBA, interval and interrupt in the I/O sequence. The ID is the identification number of the I/O. The type is the command type such as Read and Write. The LBA is the address of the I/O destination. The interval is the time interval at receiving between the previous I/O and the current I/O. The interrupt indicates whether an interrupt by the other I/O is occurred (allowed) between the previous I/O and the current I/O. If the interrupt in the current I/O pattern is not allowed, each I/O (#1-#3) is sequentially received without receiving the other I/O. Alternatively, if the interrupt is allowed, the other I/O may be intervened between the I/O (#1-#3) provided that each I/O (#1-#3) is sequentially received.

In the I/O pattern of the present embodiment, the first I/O (#1) i.e. trigger I/O is Read command to LBA “22”. The Read command does not have information of the interval and the interrupt because it is the trigger I/O. Following the first I/O (#1), the next Read Command as the second I/O (#2) to the same LBA “22” is received at the time interval of 8-10 seconds. Next, Write command as the third I/O (#3) to LBA “21” should be received at the indefinite time interval from the second I/O (#2). Since any interrupt between the first, second and third I/O is not allowed, the I/O (#1-#3) are sequentially received.

The cache control information 73A includes control classification, cache resident type, resident head position information (head LBA), resident end position information (end LBA) and preload attribute. The cache control information 73B includes the same components as the cache control information 73A. The control classification indicates the type and the ID of the cache control.

The cache resident type indicates the type and the state of the cache resident control. For example, “1” is cache resident ON, and “0” is cache resident OFF. The resident head position information (head LBA) and the resident end position information (end LBA) are the information to indicate the address and the range of the data targeted for the cache control and indicate the position of the data 32 of the HDD 30 to be resided on the CM 130, for example. When the cache resident control is performed, the data 32 on the HDD which is indicated by the head LBA and the end LBA is cached or executed the staging process on the CM 130 as the cache resident data 33 by the DKC 10. The preload attribute indicates whether the cache control target data 32 is previously loaded (executed the staging process) on the CM 130 upon determining that the data 32 is the cache resident ON. For example, “1” is the preload ON.

<I/O Pattern Determination>

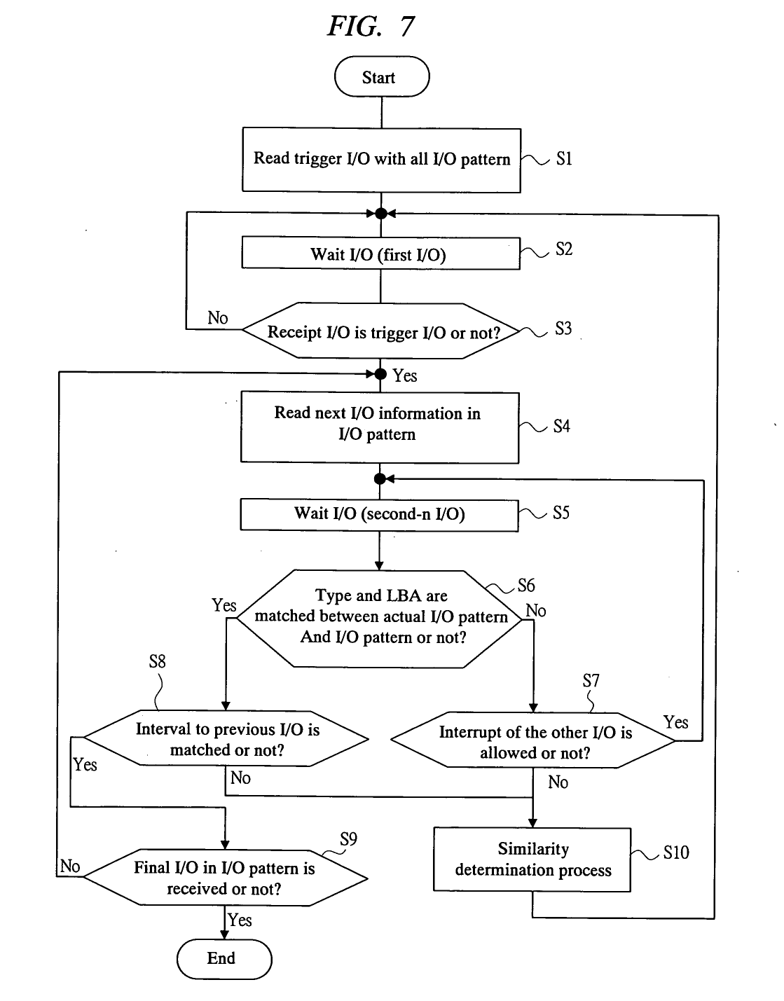

FIG. 7 is a flowchart of the process of the I/O pattern determination. The DKC 10 determines the specified I/O pattern in the I/O sequence received from the host 2 under the control of the CPU 101 according to the present flow chart. If the actual I/O pattern information 72B in the received I/O sequence is matched with the defined I/O pattern information 72A, the cache control information 73 corresponding the defined I/O pattern information 72A is read out and the cache resident control is performed according to the cache control information 73.

Firstly, in the step S1, the CPU 101 reads the trigger I/O in the overall I/O pattern from the defined I/O pattern information 72A in the defined DB 60A into the system memory 102. Taking FIG. 6 as an example, the trigger I/O in one defined I/O pattern is the Read command as I/O#1. The CPU 101 reads the information of the pertinent I/O in the I/O sequence of the defined I/O pattern information 72A, such as the ID, the type, the LBA, the interval and the interrupt.

Next, in the step S2, the CPU 101 waits a reception of the I/O request (a first I/O) from the host 2. Receiving the I/O request from the host 2, the CPU 101 determines whether the received I/O request from the host 2 is matched with the read trigger I/O in the step S3. Where, the CPU 101 determines with reference to the information such as the command type and the LBA included in the I/O request. If the received I/O request is not matched with any trigger I/O (No), the CPU 101 waits a next I/O request (S2).

Incidentally, the process for the I/O pattern determination may be performed upon receiving the I/O request at the CHA 110, and the process may be performed after the I/O is responded.

If the received I/O request is matched with the trigger I/O (Yes), the CPU 101 reads the I/O information (a second I/O) following the trigger I/O (the first I/O) in the step S4. Taking FIG. 6 as an example, the second I/O is the Read command as I/O #2. Then, the CPU 101 waits a reception of the next I/O (the second I/O) request from the host 2 in the step S5.

Receiving the next I/O request, the CPU 101 compares the actual I/O patterns consisting of the received I/O sequence with the defined I/O pattern to determine whether the items such as the type, LBA and so forth in the I/O are matched in the step S6. It is determined whether the I/O pattern is fully matched in the first embodiment. Taking FIG. 6 as an example, the first I/O and the second I/O are the I/O#1 and I/O#2 sequence, respectively. Accordingly, it is determined whether the I/O#1 and I/O#2 sequences are matched with the received I/O sequence.

If the actual I/O pattern is not matched with the defined I/O pattern (No) in the determination, the CPU 101 determines whether the interrupt of the other I/O into the I/O in the actual I/O pattern is allowed based on the defined I/O pattern information 72A in the step S7. If the interrupt of the other I/O into the pertinent defined I/O pattern is allowed (Yes), return to the step S5 and wait a reception of the next I/O request (the second I/O) because there is a possibility that the I/O pattern is matched with the after received I/O. In this case, if the I/O matched with the second I/O in the pertinent defined I/O pattern is received such that the allowed other I/O is sandwiched between the previous I/O and the I/O matched with the second I/O in the pertinent defined I/O pattern, the determination regarding the pertinent defined I/O pattern is continued.

If the interrupt of the other I/O is not allowed in the step S7 (No), it is determined that the matching with the pertinent defined I/O pattern does not exist and return to the step S2. Then the CPU 101 waits again a reception of the different I/O and starts the process regarding the different I/O pattern. In the same way, the determination of the I/O pattern is repeated every receiving the I/O.

If the determination in the step S7 and S8 is No, the similarity determination process in the step S10 is performed in the third embodiment, however, it is not performed and advance to a next process in the first embodiment.

If the actual I/O pattern and the pertinent defined I/O pattern are matched in the step S6 (Yes), subsequently, the CPU 101 determines whether the interval between the received I/O and the previously received I/O is matched with that of the pertinent defined I/O pattern in the step S8. Taking FIG. 6 as an example, since the interval between the second I/O and the first I/O in the pertinent defined I/O pattern is prescribed 8-10 seconds, it is checked whether the time difference of the actual reception falls within the prescribed time.

If the interval between the received I/O and the previous I/O is not matched (No), it is determined that the matching with the pertinent I/O pattern does not exist, and returns to the step 2, then the CPU 101 performs again the process regarding the different I/O pattern. If the interval is matched (Yes), the CPU 101 determines whether the final I/O in the pertinent defined I/O pattern is received as the actual I/O pattern in the step S9. If the final I/O has not been received (No), return to the step S4. Then, the CPU 101 reads the next I/O information in the pertinent defined I/O pattern, and repeats the process in the same way until the final I/O (#n) is received or the I/O pattern is mismatched. If the final I/O in the pertinent defined I/O pattern is received (Yes), the I/O pattern determination process is completed. Taking FIG. 6 as an example, one I/O pattern is prescribed with the I/O#1-#3. When the I/O#1 and I/O#2 have been received but the final I/O#3 has not been received in the step S9, returns to the step S4 and the I/O#3 is processed. Then If it is confirmed that the final I/O#3 is received in the step S9 again, it is determined that the actual I/O pattern and the pertinent defined I/O pattern are matched.

After the I/O pattern determination process, the host system and the critical I/O corresponding the found specified I/O pattern is estimated so that the cache control process for the specified I/O pattern is subsequently performed.

<Cache Control>

An example of the cache control by the first means is described. In the normal cache control provided with the CM 130, the data is cached on the CM 130 according to LRU algorithm. Additionally, in the cache control by the first means, the cache resident control is performed.

In the conventional cache resident control, the host 2 or the user of the host 2 can instruct the disk array device 1 to make resident ON/OFF. Additionally, the data in units of block on the HDD 30 can be resident ON/OFF all together. Thereby the cache bit rate for the data can be improved and in its turns the information process system performance can be entirely improved.

The first means sets the cache resident ON/OFF on the CM 130 to the data 32 in the LU 31 on the HDD 30 using the cache control information 73. The DKC 10 performs the cache resident control according to the cache control information 73 after the I/O pattern is determined. When the cache control is performed according to the cache control information 73, the data is stored on an area in the CM 130 in units of block specified by the LBA.

The data 32 set to the cache resident ON corresponding to the specified I/O pattern and the critical I/O according to the cache control information 73 is read from the area in the HDD 30 to the area in the CM 130 in the staging process (a5) and stored as the cache resident data 33.

The DKC 10 preferentially obtains the area for the cache resident on the CM 130. The data 32 specified as the cache resident OFF is written from the area in the CM 130 to the area in the HDD 30 and stored in the destaging process (reverse process to a5).

In the I/O to the data 32 specified as the cache resident ON among the I/O from the host 2, the cache resident data 33 on the CM 130 is read/written to respond to the hot 2 (a6). In the data on the CM 130, as usual regarding the control of the cache, the original data 32 in the HDD 30 is written to update and reflect at the appropriate timing, i.e. the timing at which the I/O request (a2) is not received in the DKC 10 for example.

Incidentally, the cache resident ON to correspond to the critical I/O is described above, however, the data 32 made to be cache resident ON once may be turned cache resident OFF at a predetermined opportunity. For example, when the pertinent cache resident data 33 is not accessed for a predetermined period, the data 32 may be turned cache resident OFF.

AS one measure against the critical I/O, the destaging process from the CM 130 to the storage area in the HDD 30 can be prevented during the life extension process in the HDD 30 by the conventional cache control. In this case, when the request for writing data into the area in the HDD 30 is issued from the host 2 in the life extension process, the write data is written into not the pertinent HDD 30 but only the CM 130 and then, the data written on the CM 130 is executed the destaging process to the storage area in the pertinent HDD 30 after the life extension process in the HDD 30 is completed thereby the answer delay in the critical I/O can be prevented. However, in case that the target read data does not exist on the CM 130 when the request for reading the data from the area in the HDD 30 issued from the host 2 in the life extension process (i.e. cache miss-hit), the read access to the HDD 30 in the life extension process is occurred so that the answer delay to the critical I/O can not be prevented.

<Control Timing>

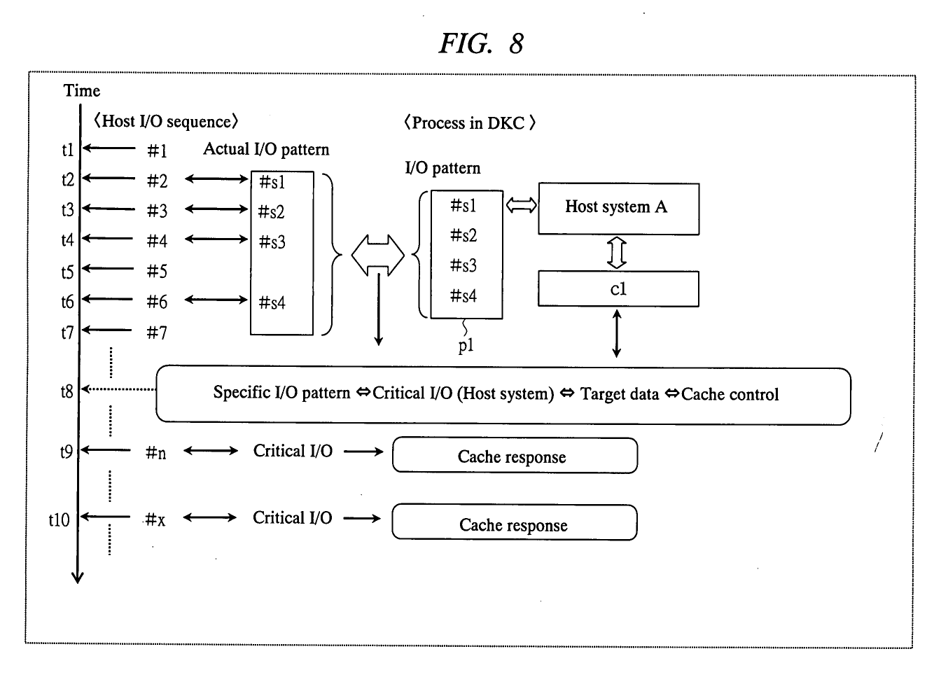

FIG. 8 is an explanatory view representing the timing between the I/O sequence from the host 2 in the disk array device 1 and the control by the first means with time base.

The I/O#1-I/O#7 in the I/O sequence from the host 2 are sequentially received and processed at the time t1-t7 by the DCK 10 from the outside. The actual I/O pattern consisting of I/O#2, #3 #4 and #6 from a certain same host 2 corresponds to the defined I/O pattern (referred to as p1) consisting of I/O#s1, #s2, #s3 and #s4 in the present embodiment. The p1 as the defined I/O pattern information 72A, c1 as the cache control information 73A and host system A as the host information 71A are corresponded in the defined DB 60A.

The DKC 10 compares the actual I/O pattern information 72B from the received I/O sequence with the defined I/O pattern information 72A to determine. The host system from which the actual I/O pattern is issued and its critical I/O are corresponded in the DB 60A based on the specified I/O which is extracted by the determination. That is to say, it is determined whether the I/O following the actual I/O pattern is the critical I/O.

The DKC 10 recognizes the specified I/O pattern and refers the host information 71A and the cache control information 73A corresponded to the pertinent defined I/O pattern 72A in the DB 60 to perform the cache control to the target data 32 corresponded to the critical I/O or the host system (t8). In the cache control, the DKA 140 reads the target data 32 from the HDD 30 and stores it on the area in the CM 130 in preparation for the critical I/O request estimated to be received after the actual I/O pattern. For example, the DKC 10 makes the data 32 targeted for the cache control be cache resident ON to store it on the area in the CM 130 (staging process) according to the instruction to make the cache resident ON in the pertinent cache control information 73A.

Then, it is assumed that the estimated critical I/O (#n) is actually issued from the host 2 at the time t9. Since the target data 32 for the critical I/O (#n) has made to be cache resident on the CM 130 as the cache resident data 33, the DKC 10 can immediately respond using the cache resident data 33. Then (t10), if the associated critical I/O (#x) is issued, the DKC 10 can respond using the cache resident data 33 in the same way.

<HDD State>

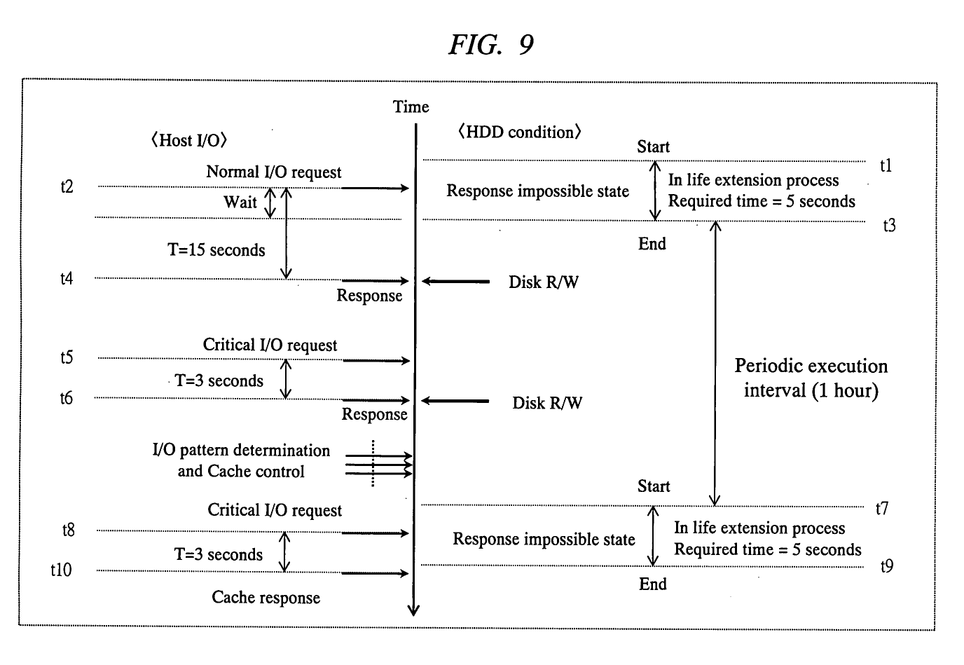

FIG. 9 is an explanatory view representing the relationship between the I/O from the host 2 in the disk array device 1 and the state of HDD (SATA drive) 30, and an example of process sequence with time base.

Where, the I/O from the host 2 includes the normal I/O and the critical I/O. The normal I/O is the above described usual I/O corresponding to Read/Write command. The required response time of the normal I/O is longer than the duration for the response impossible state in the HDD 30. The critical I/O is corresponding to Read/Write command. The required response time of the critical I/O is shorter than the duration for the response impossible state in the HDD 30. The required response time (T) in the normal I/O request from the host 2 is fifteen seconds for example. The required response time (T) in the critical I/O request from the host 2 is three seconds for example. The duration for the response impossible state in the HDD 30 is five seconds for example. Where, the required response time is the time limit or the time out value for the waiting allowed by the host 2 during which the I/O request (a2) is issued and the normal response (a3) is returned. If the above-described time limit or the time out value is exceeded, an error and system down are occurred. The required response time is determined depending on the host system. However, the host system is unknown, the required response time can not be known to the disk array device 1.

The HDD 30 state includes the response possible state and the response impossible state. The response possible state is a state that the access request to the disk for the I/O request received in the DKC 10 can be immediately responded by the HDD 30 to be accessed. The response impossible state is a state that the access request can not be responded by the HDD 30 to be accessed without occurring a waiting time and so forth.

The response impossible state is equivalent to the state in the life extension process in the SATA drive (30) in the present embodiment. The required time for automatically performing the life extension process in the HDD 30 is five seconds for example. Additionally, the life extension process is regularly performed in a certain HDD 30 and the execution interval is an hour from the previous execution. Hereinafter, one HDD 30 is paid attention to consider.

Firstly, the HDD 30 is in the life extension process during the time t1-t3 thereby to be response impossible state to the access request from the DKC 10. Meanwhile, the normal I/O is occurred in the host I/O at the time t2. At this time, since the HDD 30 to be accessed is in the response impossible state, an waiting is occurred until the response becomes possible. The HDD becomes the response possible state after the life extension process is completed. The I/O request is normally processed at the time t4. That is to say, the access request from the DKC 10 to the pertinent HDD 30 is performed responsive to the I/O request and responded through the I/O to the target data.

Then, the critical I/O request is issued from the host 2 at the time t5. At this time, since the HDD 30 is in the response possible state, the response is allowed within three seconds as the required response time t6 even if the access to the disk is required. If the access to the CM 130 is required, the response is of course allowed.

Then, a periodic life extension process is performed in the HDD 30 thereby the response impossible state is occurred in the time t7-t9. The critical I/O is issued from the host 2 at the time t8 in the life extension process. Where, if the I/O pattern determination and the cache control corresponding to the actual I/O pattern associated with the critical I/O are performed before the time t8, the I/O target data 32 is made to be cache resident on the CM 130. Accordingly, even if the response impossible state occurs in the HDD 30, the cache resident data 33 on the CM 130 enables a cache response thereby the normal response within the required response time is achieved.

<Cluster System>

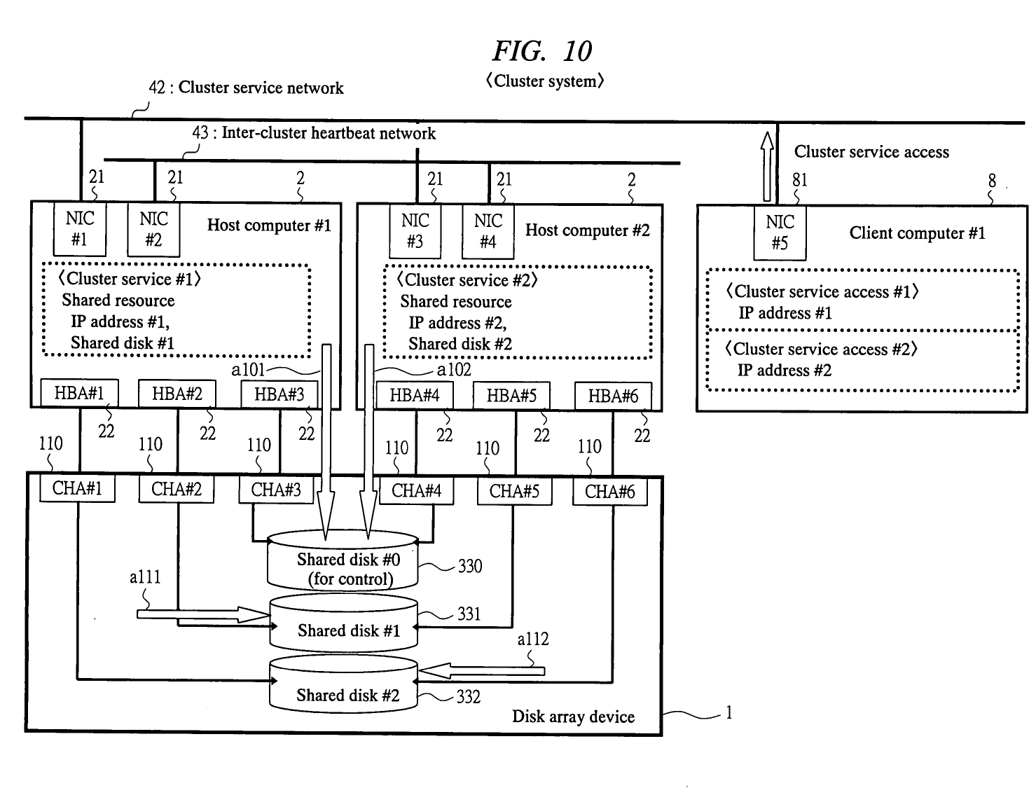

Next, the cluster system as an example of a host system to issue the critical I/O is described. FIG. 10 represents more detailed constructional example of the clustered system of FIG. 2. The cluster system comprises a disk array device 1, a plurality of hosts 2 communicatively connected to the disk array device 1 and a client computer 8 communicatively connected to the host 2. Each network 42 and 43 is a LAN connected based on such as TCP/IP protocol. Where, the cluster is composed of two hosts 2 for ease of explanation.

The client computer 8 includes a CPU and a memory (not shown in the figure), a NIC (Network Interface Card) 81 to interface to a cluster service network 42 and holds on the memory information to access to the cluster service provided by the cluster of the host 2.

The host {#1 and #2} 2 comprises the CPU, the memory, a NIC 21 and a HBA 22 (Host Bus Adapter). The host 2 holds information to provide the cluster service on the memory. The cluster system is constructed on the host 2 by executing the specific cluster software program. The cluster service of the host 2 utilizes the facility provided by the disk array device 1.

The host 2 is connected to the network 41 through the HBA 22 and able to be communicated with the CHA 110 in the DKC 10 of the disk array device 1. The host 2 is also connected to the cluster service network 42 through the NIC 21 and communicatively connected with the client computer 8. Receiving the cluster service access from the client computer 8, the host 2 provides the cluster service thereto. The host 2 is further connected to the inter-cluster heartbeat network 43 through the other NIC 21 thereby heartbeat communication is performed between the hosts 2 over the inter-cluster heartbeat network 43.

The critical I/O request includes an access to the shared disk in the cluster system and an access for a path health check in the middleware to check the path health, for example. Those critical I/O requests is required the responsibility within the short required response time to check the system state. If it is impossible to respond within the required response time, undesirable failover (service takeover) and system down are occurred.

In order to improve the performance and the fault tolerance in the cluster system, a plurality of servers (equivalent to the host 2) are cooperated on the cluster service network 42 to operate as one large system. Thereby another server (2) replaces with one server (2) to take over the service if the one server (2) is failed so that the work can be continued. Those cluster systems generally uses means of communication such as LAN (equivalent to the inter-cluster heartbeat network 43) to perform the heartbeat communication thereby to monitor the operating state each other. If the service provided from one host 2 is failed and stopped in the state that it is possible to communicate, higher priority computer among the remaining hosts 2 takes over the service thereby the client computer 8 can be continually provided the service.

However, if it is impossible to communicate over the means of communication (43) such as the LAN due to the path failure, the priority control between the computers in performed by means of read/write processing to an external storage unit shared with the plurality of host 2. Hereinafter the shared external storage unit used for the priority control will be referred to as a cluster shared disk. The cluster shared disk is held in the storage volume on the HDD 30 of the disk array device 1. The cluster shared disk is a shared resource used for the inter-cluster communication, which is required other than the network. A shared disk #0 (330) of FIG. 10 is equivalent to the cluster shared disk. The host 2 performs the control I/O access to the cluster shared disk (330) to indicate that the host 2 normally operates. For example, information such as host number and the number of access is written in the cluster shared disk (330). The host 2 reads the information written in the cluster shared disk (330) thereby to determine whether the other host 2 is in operating state or down state.

In the priority control, the host 2 which firstly accesses to the cluster shared disk (330) obtains the priority, takes over the service to continuously provide in practice. If an I/O error and time out is occurred, i.e. it is impossible to respond within the prescribed time at the access to the cluster shared disk (330), the host 2 can not provide the service thereby the cluster system terminates abnormally so that the service is down.

For example, the host #1 provides the service of cluster service #1 and issues the I/O to a shared disk #1 (331) as the shared resource every three seconds to check the disk state. If the inter-cluster heartbeat network 43 is failed, the host #1 and #2 in the cluster configuration issue the I/O to the cluster shared disk (330), respectively. Then, the host 2 which firstly accesses to the cluster shared disk (330) takes over and provides the two cluster service #1 and #2 defined in the cluster configuration. In the case of a cluster system defined that the responsibility required for the I/O issued from each host #1 and #2 to the cluster shared disk (330) is three seconds, if the host can not obtain the response after the lapse of five seconds and both of the host #1 and #2 can not obtain the response, neither of the host 2 takes over the service so that the service of the cluster system is down. Where, the I/O issued from each host 2 to the cluster shared disk (330) is Read/Write to the specified LBA thereby to estimate the critical I/O.

In FIG. 10, the host #1 includes a NIC #1 (21) to connect to the cluster service network 42, a NIC #2 (21) to connect to the inter-cluster heartbeat network 43 and a HBA#1-#3 (22) to connect to the CHA #1-#3 (110) of the disk array device 1. The host #1 holds information of the I/P address #1 and the shared disk #1 as the information of the shared resource of the cluster service #1. The host #2 has the same configuration as that of the host #1 and holds information of the I/P address #2 and the shared disk #2 as the information of the shared resource of the cluster service #2. Further, the client computer 8 includes a NIC #5 (81) to connect to the cluster service network 42 and holds information of the IP address #1 for a cluster service access #1 and the IP address #2 for a cluster service access #2.

Moreover, a shared disk for the cluster service is set on the HDD 30 in the disk array device 1. The shared disk is equivalent to such as a LU. A shared disk #0(330), #1(331) and #2(332) are set in the disk array device 1 in the present embodiment. The shared disk #1(331) and #2(332) corresponds to a normal access a111 and a112, respectively, and are used for the normal data I/O in the cluster service. The client computer 8 accesses to the IP address #1 to connect to the cluster service #1 in the host #1 so that the data I/O is performed to the shared disk #1 (331) corresponding thereto by the normal access a111. In the same way, the client computer 8 accesses to the IP address #2 to connect to the cluster service #2 in the host #2 so that the data I/O performed to the shared disk #2 (332) corresponding thereto by the normal access a112.

Meanwhile, the shared disk #0 (330) corresponds to the cluster shared disk and is performed priority control access a101 and a102 from each host #1 and #2. Each host #1 and #2 performs access a101 and access a102 for control to the shared disk #0 (330) in the disk array device 1.

The critical I/O from the cluster system can be responded within the required response time under the control of the first means so that system failure such as failover and service down undesirable for the cluster system can be prevented in the first embodiment.

As thus described above, according to the first embodiment, the life extension process capability of the HDD 30 in its own is performed so that the reliability of the HDD 30 as an individual body is improved even if the disk array device 1 employs the HDD 30 such as the SATA drive having the reliability somewhat lower than that of the FC drive. Additionally, the response to the critical I/O request from such as the cluster system is effectively processed particularly by means of the cache resident control without occurring an answer delay so that an error and system down can be prevented thereby the system availability can be improved. Further, the data 32 in units of block required for the critical I/O from the host system is previously made to be cache resident on the CM 130 so that it is possible to respond within the required response time regardless of with or without the life extension process in the HDD 30.

Additionally, in the case of the critical I/O to the HDD not having the life extension process facility, the I/O performance also can be improved by performing the cache resident control. In the case that the access request to the HDD 30 is temporarily stopped in the life extension process control by the DKC 10 in order to effectively perform the life extension process in the HDD 30, even if the critical I/O to the pertinent HDD 30 is occurred in the stopping time, it is possible to respond by previously performing the cache resident control. Incidentally, the first critical I/O is responded by accessing to the HDD 30 and recognized by determining the I/O pattern thereby the cache control is performed, and the subsequent critical I/Os may be responded using the cache controlled data. The information of the DB 60 may be placed in the outside of the disk array device 1 and the information may be read to use according to need. Even if the required response time for the I/O from the host system is unknown, it is possible to respond. However, if the required response time for the specified I/O is known, the information may be registered in the DB 60 to use for the determination.

### Embodiment 2

Next, the disk array device 1 according to the second embodiment of the present invention is described with reference to FIG. 1-FIG. 10. In the second embodiment, second means composed of the hardware and the software captures information such as the I/O trace based on the I/O from the host system, and the information is used to respond to the critical I/O from the un-corresponding and unknown host system to the defined DB 60A.

If the host system configuration is matched with the information registered in the defined DB 60A, the critical I/O can be responded under the above-described control in the first embodiment. In the case of the system configuration according to the specific OS, middleware and application in the host 2, the cache control information 73A corresponding thereto is previously created and stored in the disk array device 1 so that it is possible to respond, for example.

However as for an unknown host system, such as the combination of each version of the specific OS, middleware and application in the host 2, the cache control information 73 available for the combination is not always held previously in the DB 60 of the disk array device 1. In this case, the actual I/O pattern must be fully matched with the defined I/O pattern in order to respond the critical I/O request.

<Capture of I/O Trace>

In the second embodiment, such as the cache control information 73A and the defined I/O pattern information 72A corresponding to the host system configuration, which are held in the disk array device 1 as the defined DB 60A are exchangeable and updatable. That is to say, the DB 60A can be updated or upgraded depending on the change of the host system configuration.

The disk array device 1 is provided with means for capturing the trace of the I/O received from other devices including the host 2 as second means. The second means is provided by manipulating a control program 91 to monitor the I/O from the host 2 in the DKC 10 and capture the I/O trace according to the instruction from the SVP 160. The I/O trace is a part of or the entire record of the sequence of such as the I/O requests or commands received at DKC 10 and the I/O response processing result corresponding thereto. The CPU 101 of the DKC 10 or the other processor captures the I/O trace of the I/O received from the host 2. The captured I/O trace is stored in any memory in the disk array device 1.

In the second embodiment, the SVP 160 instruct the DKC 10 to capture the I/O trace by manipulating the control program 161 thereby the DKC 10 captures the I/O trace information according to the instruction. The I/O trace information captured by the DKC 10 is collected in the SVP 160 and transmitted to and retrieved in other devices such as the maintenance center 51 through means of communication.

For example, if there is an unknown host system, the operator instructs the disk array device 1 to start and terminate to capture the I/O trace or the time thereof through the SVP 160. The DKC 10 captures the I/O trace from the host 2 within, for example, a certain time according to the instruction. The captured I/O trace information is added the host information via the SVP 160 and stored in any position in the disk array device 1. The stored I/O trace information can be utilized to create the I/O pattern information 72 and the cache control information 73 available for the unknown host system.

For example, the verification center 52 analyzes the captured I/O trace information, and the defined DB 60A held in the verification center 52 is updated according to the host information 71, the I/O pattern information 72 and the cache control information 73 which are newly created based on the analysis.

Incidentally, each processing section in the DKC 10 transmits the processing state information to the SVP 160 so that the SVP 160 may recognize the I/O state and obtain the I/O trace information. Additionally, the DKC 10 may capture the I/O trace automatically and record it according to the setting without through the operator and the SVP 160.

Thus according to the second embodiment, even if an un-corresponding and unknown host system configuration to the DB 60, the I/O trace of the host system can be captured according to the instruction/input by the operator, and the available definition information can be created and updated by analyzing the captured I/O trace information. Accordingly, the critical I/O from the unknown host system can be additionally responded thereby the information process system reliability can be improved.

### Embodiment 3

Next, the disk array device 1 according to the third embodiment of the present invention is described with reference to FIG. 1-FIG. 10. In order also to respond to the change of the configuration due to the version up of such as the OS and the correction at the patch level in the host system, the disk array device 1 is provided with means as third means for applying the cache control information 73 the same as the similar host system to perform the cache control thereby to respond the critical I/O if the actual I/O pattern from the host 2 is similar to the defined I/O pattern in the third embodiment.

<Similarity Determination>

In the third embodiment, the similarity determination process is performed in the step s10 of FIG. 7. The DKC 10 compares the actual I/O pattern from the host 2 or the captured I/O trace information with the defined I/O pattern information 72 A in the defined DB 60A and extracts the specified I/O pattern to determine. As for the determination, not only the case that the actual I/O pattern from the host 2 is fully matched with the defined I/O pattern in the step S6 of FIG. 7 but also the similar I/O pattern based on the similarity determination in the step S10 is extracted. If those I/O pattern has similarity within an allowance, it is determined that the host system configuration is similar to that of the host system registered in the defined DB 60A. Then, the cache control information 73A corresponds to the similar host system relative to the similar I/O pattern and critical I/O to perform the cache control. Thereby the critical I/O request from the unknown host system can be responded.

If it is “No” in the step S7 and S8, the actual I/O pattern and the defined I/O pattern is not fully matched. Then, the similarity between the actual I/O pattern and the defined I/O pattern is determined with reference to the similarity determination information 74 in the step S10. If the similarity within an allowance is appeared, the host 2 which issues the actual I/O pattern is assumed as the host system similar to the host system corresponding to the pertinent defined I/O pattern and performed the cache control by applying the cache control information 73 in the defined DB 60A same as described above. Alternatively, the determination by the comparison including the similarity determination is performed in the step S6 instead of the determination by the comparison whether it is fully matched.

In the defined I/O pattern information 72A of FIG. 6, the pattern matching rate in the similarity criteria is set to the allowed value 99%-80% for example. Similarly, the I/O time lag is set to half-double. The other I/O interrupt is set to 3 I/O. As for the pattern matching rate, when the similarity between the defined I/O pattern and the actual I/O pattern is evaluated in consideration of the factor such as I/O interval, there is the similarity between the two, that is to say, those are the similar host systems. The I/O time lag is the difference between each I/O sequence and the time difference of the receipt time of the I/O command. For example, if the time lag between each I/O falls within half-double, it is allowed. As for the other I/O interrupt, the reception of the other I/O intervened between I/Os in the I/O sequence is allowed within three.

If the similarity in the I/O pattern is found in the similarity determination process, the cache control information 73A of the similar host system is applied, and the DKC 10 registers the I/O pattern information 72B and the cache control information 72B as the similar host system configuration in the additional DB 60B. Since then, the disk array device 1 also refers to the registration information of the additional DB 60B to control so that the critical I/O from the similar host system which is determined the similarity once can be responded.

### Embodiment 4

Next, the disk array device 1 according to the fourth embodiment of the present invention is described with reference to FIG. 1-FIG. 10. In the fourth embodiment, as a fourth means, the disk array device 1 further comprises means for transmitting the related information in the disk array device 1 such as the DB 60 and the I/O trace information to the external devices such as the maintenance center 51 and the verification center 52 to retrieve; creating the definition information corresponding to the latest host system configuration by evaluating and analyzing the host system based on the retrieved information to update the defined DB 60A; distributing the updated information to one or more disk array devices (1 and 1B) as distribution information; and reflecting the information in the DB 60 to update the DB 60.

<Information Retrieval, Verification, Update and Distribution>

In the fourth embodiment, the related information such as the I/O trace information in one disk array 1 is retrieved to the maintenance center 51 through the SVP 160 and means of communication. Firstly, the I/O trace information is transmitted and collected from the DKC 10 to the SVP 160. Then, the I/O trace information is transmitted from the SVP 160 to the computer of the maintenance center 51 through the network to retrieve it. The retrieved information is transmitted from the computer of the maintenance center 51 to the verification center 52.

In the verification center 52, the evaluation and analysis for the host system is performed based on the retrieved I/O trace information, and the regularity of the I/O pattern is derived by the verification to estimate the system configuration of the host 2. Then, the available cache control information 73 is created according to the derived I/O pattern. The definition information including the association of the I/O pattern information 72A with the cache control information 73A, which is newly created in the verification center 52 is additionally registered or reflected in the defined DB 60A held in the verification center 52 to update. That is to say, the defined DB 60A is upgraded depending on the host system configuration. The computer of the verification center 52 redistributes and processes the information in the defined DB 60A to one or more disk array devices in operation through the maintenance center 51 in the form of redistributable information via the SVP 160. The information is distributed to all of the disk array devices (1 and 1B in the present embodiment) under the control of the maintenance center 51. Alternatively, the information may be distributed to apart of the disk array device (only 1 for example) The defined DB 60A held in each disk array device 1 is DB-updated through the SVP 160 according to the distribution. The DKC 10 or the SVP 160 reflects the distributed information in the defined DB 60A held in the disk array device 1 to update.

According to the fourth embodiment, the information in the defined DB 60A is distributed and updated so that the host system configuration which can respond to the critical I/O is added to not only the disk array device 1 from which the related information is retrieved but also the plurality of disk array devices including another disk array device 1B thereby to efficiently adapt to the latest host system configuration and the information process system reliability can be improved.

While the present invention has been described in conjunction with preferred embodiments thereof, it is to be understood that the present invention is not intended to be limited to the above described embodiments, and various changes may be made therein without departing from the spirit of the present invention.

The present invention can be applied to an external memory and information process systems including the external memory.

What is claimed is:

1. A disk array device comprising a storage unit and a storage control unit having a cache memory for controlling data storage to the storage unit, and performing data I/O processing to the storage unit responsive to an I/O request,
wherein a response impossible state to an access request including data read from or write to the storage control unit occurs in the storage unit, and
wherein the storage control unit determines a specified I/O pattern in the I/O, previously performs a cache control to critical I/O target data associated with the specified I/O pattern using the cache memory according to definition information, and responds to the critical I/O using the target data cache controlled on the cache memory when the critical I/O occurs.

2. The disk array device according to claim 1, wherein
the disk array device holds a database in which the definition information is registered,
the definition information includes I/O pattern information representative of a defined I/O pattern and cache control information corresponding to the I/O pattern information and indicative of the target data and the content of the cache control, and
the storage control unit compares an actual I/O pattern in a received I/O sequence with the defined I/O pattern, extracts as the specified I/O pattern if the actual I/O pattern in the received I/O sequence and the defined I/O pattern are matched to determine the I/O pattern, and performs the content of the cache control to the target data according to the cache control information corresponding to the extracted I/O pattern.

3. The disk array device according to claim 1, wherein
the storage control device performs the following processes as the cache control: reading the target data corresponding to the extracted I/O pattern from an area in the storage unit; and storing the target data in an area on the cache memory as cache resident data.

4. The disk array device according to claim 1, wherein
the storage unit performs a life extension process involving seek operation to the disk when the access request is not issued from the storage control unit, and
the response impossible state is a state in operating the life extension process.

5. The disk array device according to claim 1, wherein
the cache control target data is the critical I/O target data received following the specified I/O pattern.

6. The disk array device according to claim 1, wherein
the disk array device further comprises a supervising unit connected to the storage control unit,
the supervising unit instructs the storage control device to capture an I/O trace, collects information including the captured I/O trace according to the instruction from the disk array device and transmits the collected information to an external device which is communicatively connected thereto to retrieve, and
the storage control unit captures the I/O trace according to the instruction.

7. The disk array device according to claim 1, wherein
the disk array device holds a defined database in which the definition information is registered,
the definition information includes the I/O pattern information representative of the defined I/O pattern, the cache control information corresponding to the I/O pattern information and indicative of the target data and the content of the cache control, and similarity determination information in the I/O pattern, and
the storage control unit compares the actual I/O pattern in the received I/O sequence with the defined I/O pattern, extracts the actual I/O pattern in the received I/O sequence as the similar I/O pattern to the defined I/O pattern if the similarity between the actual I/O pattern in the received I/O sequence and the defined I/O pattern is appeared within an allowance based on the similarity determination information to determine the I/O pattern, applies the cache control information corresponding to the defined I/O pattern to the similar I/O pattern, performs the content of the cache control to the target data and registers a definition information including the correspondence between the similar I/O pattern and the defined I/O pattern in the additional database.

8. The disk array device according to claim 1, wherein
the disk array device further comprises a supervising unit connected to the storage control unit, and
the supervising unit manages the database in which the definition information is registered, receives the definition information newly created or updated based on the verification of the information transmitted and retrieved from the supervising unit to an external device through means of communication from the external device through the means of communication, and reflects it in the database to update.

9. The disk array device according to claim 1, wherein
the disk array device further comprises a supervising unit connected to the storage control unit, and
the supervising unit manages the database in which the definition information is registered, receives the definition information distributed to a plurality of disk array devices, which is newly created or updated in an external device communicatively connected to the supervising unit from the external device through the means of communication and reflects it in the database to update.

10. A disk array device comprising a storage unit and a storage control unit for controlling data storage to the storage unit, and performing data I/O processing to the storage unit responsive to an I/O request, wherein
the storage control unit comprises a processor for controlling the I/O, a channel control unit having an interface to the other devices for performing communication processing, a cache memory, a disk control unit having a interface to the storage unit for performing communication processing and a junction unit to interconnect therebetween,
the storage unit is connected to the disk control unit in the storage control unit over the network and includes means for performing a life extension process involving seek operation to the disk when the access request is not issued from the storage control unit and becomes the response impossible state to an access request including data read from/write to the storage control unit in the life extension process, and
the storage control unit determines a specified I/O pattern in the I/O, previously performs a cache control to the critical I/O target data associated with the specified I/O pattern using the cache memory according to definition information, and responds to the critical I/O using the target data cache controlled on the cache memory when the critical I/O is occurred.
